(19) United States
(12) Patent Application Publication
(10) Pub. No.: US 2018/0117772 A1
(43) Pub. Date: May 3, 2018

(54) HAND AND ROBOT

(71) Applicant: Seiko Epson Corporation, Tokyo (JP)

(72) Inventor: Tomo IKEBE, Suwa (JP)

(21) Appl. No.: 15/783,350

(22) Filed: Oct. 13, 2017

(30) Foreign Application Priority Data
Oct. 31, 2016 (JP) 2016-212639
Oct. 31, 2016 (JP) 2016-212646

(51) Int. Cl. B25J 13/08; B25J 15/00

(52) U.S. Cl. CPC B25J 13/081; B25J 15/0028; B25J 15/0004

(57) ABSTRACT

A hand includes a grasper that grasps a target object and a sensor section that detects force exerted on the grasper when the grasper grasps the target object, and the sensor section includes a pressure sensitive section including a resin and carbon nanotubes. The sensor section includes a first sensor section located between the target object and the grasper in a state in which the grasper grasps the target object.

### BACKGROUND

### 1. Technical Field

The present invention relates to a hand and a robot.

### 2. Related Art

As a hand attached to a robot (industrial robot) used, for example, in the step of manufacturing an industrial product, the hand described in JP-A-2004-24134 is known. The hand described in JP-A-2014-24134 (electrically driven hand) includes a pair of slidable graspers (fingers) so provided as to approach each other and move away from each other and a force sensor provided on the basal end of each of the graspers. In the thus configured hand, the force sensors allow sensing of grasping force produced by the pair of graspers. Further, the force sensors are configured to be unlikely to be affected by temperature (that is, to output a value that does not greatly change due to a change in temperature).

The IC handler described in JP-A-2000-266810 tests electric characteristics of an IC under test with the IC pressed against an IC socket. The IC handler includes a pressure sensor for detecting the force with which the IC is pressed against the IC socket, and a result of the detection performed by the pressure sensor is so fed back that the IC is pressed against the IC socket with appropriate pressing force.

In the hand described in JP-A-2004-24134, however, the configuration thereof undesirably increases the size of the force sensors. Configuring the force sensors to be unlikely to be affected by temperature and reduction in size of the hand cannot therefore be achieved at the same time.

In the IC handler described in JP-A-2000-266810, since the configuration of the pressure sensor is not described, the output from the pressure sensor may change due to a change in temperature (temperature in test environment) depending on the configuration of the pressure sensor, and accurate pressing force cannot undesirably be detected.

### SUMMARY

An advantage of some aspects of the invention is to provide a hand and a robot that are unlikely to be affected by temperature and can be reduced in size.

Another advantage of some aspects of the invention is to provide a pressing apparatus that is unlikely to be affected by temperature and therefore capable of more accurately detecting pressing force and a reliable electronic part transport apparatus, an electronic part test apparatus, and a robot including the pressing apparatus.

The invention can be implemented as the following forms or application examples.

The advantages can be achieved by the following configurations.

A hand according to an aspect of the invention includes a grasper that grasps a target object and a sensor section that detects force exerted on the grasper when the grasper grasps the target object, and the sensor section includes a pressure sensitive section including a resin and carbon nanotubes.

According to the configuration including the pressure sensitive section including a resin and carbon nanotubes, a sensor section that is unlikely to be affected by temperature, that is, a sensor section that outputs a value that changes by only a small amount due to a change in temperature can be provided. Further, the size of the sensor section can be reduced. A hand that is compact and unlikely to be affected by temperature can therefore be provided.

In the hand according to the aspect of the invention, it is preferable that the sensor section is disposed between the target object and the grasper in a state in which the grasper grasps the target object.

With this configuration, the sensor section can more precisely detect the force exerted on the grasper when the grasper grasps the target object.

In the hand according to the aspect of the invention, it is preferable that the sensor section is capable of independently detecting the force in a plurality of portions of the sensor section.

With this configuration, the distribution of the magnitude of the force received by a pressure receiving surface can be obtained, whereby the state of the grasped target object can be detected in more detail.

It is preferable that the hand according to the aspect of the invention further includes a base section and a movable section movable relative to the base section, and the grasper is connected to the movable section, and the sensor section is also disposed between the movable section and the grasper.

With this configuration, the grasping force can be more accurately detected.

In the hand according to the aspect of the invention, it is preferable that the sensor section disposed between the movable section and the grasper is formed of a plurality of sensor sections arranged along a direction perpendicular to a movement direction of the movable section.

With this configuration, the weight and slippage of the target object can be more precisely detected.

In the hand according to the aspect of the invention, it is preferable that the resin contains a thermoplastic resin.

With this configuration, the pressure sensitive section can be readily manufactured.

In the hand according to the aspect of the invention, it is preferable that the resin contains polycarbonate.

With this configuration, the pressure sensitive section can be sufficiently hard, whereby the mechanical strength of the sensor section is improved.

In the hand according to the aspect of the invention, it is preferable that the resin contains a thermoset resin.

With this configuration, a thermally stable pressure sensitive section can be achieved.

In the hand according to the aspect of the invention, it is preferable that the sensor section includes a pair of electrodes, and the pressure sensitive section disposed between the pair of electrodes.

With this configuration, the configuration of the sensor section can be simplified.

In the hand according to the aspect of the invention, it is preferable that the sensor section includes a pair of electrodes, and the pair of electrodes are located on the pressure sensitive section and on the same side thereof.

With this configuration, the configuration of the sensor section can be simplified.

A robot according to another aspect of the invention includes the hand according to the aspect of the invention.

With this configuration, a reliable robot can be provided.

A pressing apparatus according to another aspect of the invention includes a pressing section that presses a target object and a sensor section that senses pressing force exerted by the pressing section on the target object, and the sensor section includes a pressure sensitive section including a resin and carbon nanotubes.

With this configuration, a pressing apparatus that is unlikely to be affected by temperature and capable of more accurately detecting the pressing force can be provided.

It is preferable that, the pressing apparatus according to the aspect of the invention includes a movement mechanism that moves the pressing section.

With this configuration, the pressing section can more reliably press the target object.

In the pressing apparatus according to the aspect of the invention, it is preferable that the sensor section is located on the side opposite the target object with respect to the pressing section.

With this configuration, the sensor section is not interposed between the pressing section and the target object, whereby the pressing section can more efficiently press the target object.

It is preferable that the pressing apparatus according to the aspect of the invention includes a heating section that is located on the side opposite the target object with respect to the pressing section and heats the pressing section.

With this configuration, the pressing section heated by the heating section can heat the target object.

In the pressing apparatus according to the aspect of the invention, it is preferable that the heating section is located in a position shifted from the sensor section toward the pressing section.

With this configuration, the heating section and the pressing section can be so disposed as to be closer to each other, whereby the heat produced by the heating section can be efficiently transferred to the pressing section.

It is preferable that the pressing apparatus according to the aspect of the invention includes a heat insulating section disposed between the sensor section and the heating section.

With this configuration, a situation in which the sensor section is heated can be avoided. Further, the heat produced by the heating section can be efficiently transferred to the pressing section.

In the pressing apparatus according to the aspect of the invention, it is preferable that the heating section is located on the side opposite the pressing section with respect to the sensor section.

With this configuration, the distance between the sensor section and the pressing section can be shortened, whereby the sensor section can more precisely detect the pressing force.

In the pressing apparatus according to the aspect of the invention, it is preferable that the resin contains a thermoplastic resin.

With this configuration, the pressure sensitive section can be readily manufactured.

In the pressing apparatus according to the aspect of the invention, it is preferable that the resin contains polycarbonate.

With this configuration, the pressure sensitive section can be sufficiently hard, whereby the mechanical strength of the sensor section is improved.

In the pressing apparatus according to the aspect of the invention, it is preferable that the resin contains a thermoset resin.

With this configuration, a thermally stable pressure sensitive section can be achieved.

In the pressing apparatus according to the aspect of the invention, it is preferable that the sensor section includes a pair of electrodes, and the pair of electrodes are located on opposite sides of the pressure sensitive section.

With this configuration, the configuration of the sensor section can be simplified.

It is preferable that the pressing apparatus according to the aspect of the invention includes a pressurizing section that pressurizes the sensor section in a state in which the pressing section does not press the target object.

With this configuration, the responsiveness of the sensor section can be improved.

An electronic part transport apparatus according to another aspect of the invention includes the pressing apparatus according to the aspect of the invention.

With this configuration, the electronic part transport apparatus can advantageously receive the advantageous effects provided by the pressing apparatus and can hence be a reliable apparatus.

An electronic part test apparatus according to another aspect of the invention includes the electronic part transport apparatus according to the aspect of the invention and a test section.

With this configuration, the electronic part test apparatus can advantageously receive the advantageous effects provided by the electronic part transport apparatus (pressing apparatus) and can hence be a reliable apparatus.

A robot according to another aspect of the invention includes the pressing apparatus according to the aspect of the invention.

With this configuration, the robot can advantageously receive the advantageous effects provided by the pressing apparatus and can hence be a reliable robot.

### BRIEF DESCRIPTION OF THE DRAWINGS

The invention will be described with reference to the accompanying drawings, wherein like numbers reference like elements.

FIG. 1 is a perspective view showing a robot according to a first embodiment.

FIG. 2 is a perspective view showing a hand with which the robot shown in FIG. 1 is provided.

FIG. 3 is a cross-sectional view showing first sensor sections with which the hand shown in FIG. 2 is provided.

FIG. 4 shows graphs illustrating the load-resistance characteristic of each of the first sensor sections.

FIG. 5 is a plan view showing each of the first sensor sections.

FIG. 6 is a cross-sectional view showing second sensor section with which the hand shown in FIG. 2 is provided.

FIG. 7 is a cross-sectional view showing other second sensor sections with which the hand shown in FIG. 2 is provided.

FIG. 8 is a plan view showing one of the second sensor section.

FIG. 9 shows the hand having grasped a workpiece.

FIG. 10 shows the hand having grasped a workpiece.

FIG. 11 shows the hand having grasped a workpiece.

FIG. 12 shows the hand having grasped a workpiece.

FIG. 13 is a perspective view showing a robot according to a second embodiment.

FIG. 14 is a cross-sectional view showing a hand according to a third embodiment.

FIG. 15 is a cross-sectional view showing a second sensor section with which the hand shown in FIG. 14 is provided.

FIG. 16 is a side view showing a hand according to a fourth embodiment.

FIG. 17 is a side view for describing an action of the hand shown in FIG. 16.

FIG. 18 is a side view for describing an action of the hand shown in FIG. 16.

FIG. 19 is a perspective view showing an electronic part test apparatus according to a fifth embodiment.

FIG. 20 is a perspective view showing a Z stage provided in the electronic part test apparatus shown in FIG. 19.

FIG. 21 is a cross-sectional view showing an electronic part holder with which the electronic part test apparatus shown in FIG. 19 is provided.

FIG. 22 is a cross-sectional view showing a variation of the electronic part holder shown in FIG. 21.

FIG. 23 is a cross-sectional view showing another variation of the electronic part holder shown in FIG. 21.

FIG. 24 is a cross-sectional view showing a pressing apparatus (electronic part holder) according to a sixth embodiment.

FIG. 25 is a cross-sectional view showing a variation of the pressing apparatus (electronic part holder) shown in FIG. 24.

FIG. 26 is a cross-sectional view showing a pressing apparatus (electronic part holder) according to a seventh embodiment.

FIG. 27 is a plan view showing the arrangement of electrodes of a sensor section.

FIG. 28 is a cross-sectional view showing a pressing apparatus (electronic part holder) according to an eighth embodiment.

FIG. 29 is a perspective view showing a robot according to a ninth embodiment.

FIG. 30 is a side view showing a robot according to a tenth embodiment.

### DESCRIPTION OF EXEMPLARY EMBODIMENTS

A hand and a robot according to a preferable embodiment of the invention will be described below in detail with reference to the accompanying drawings.

### First Embodiment

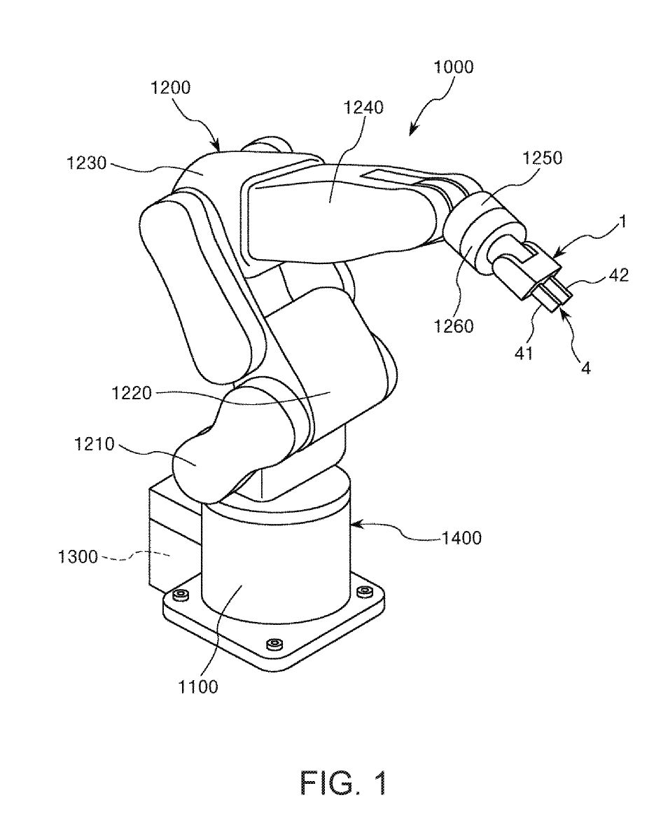

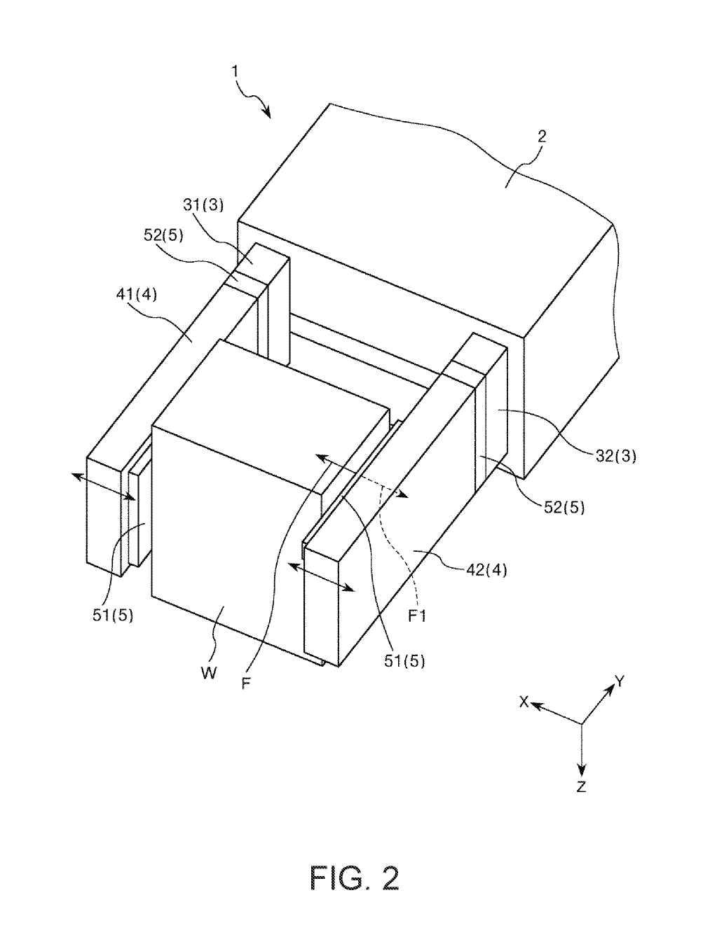

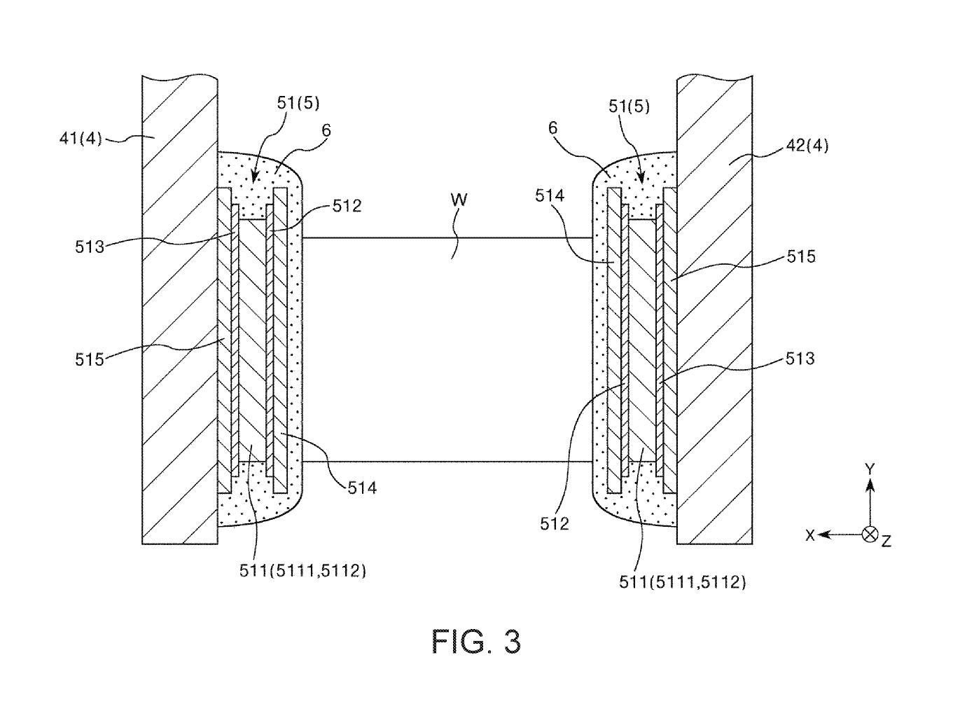

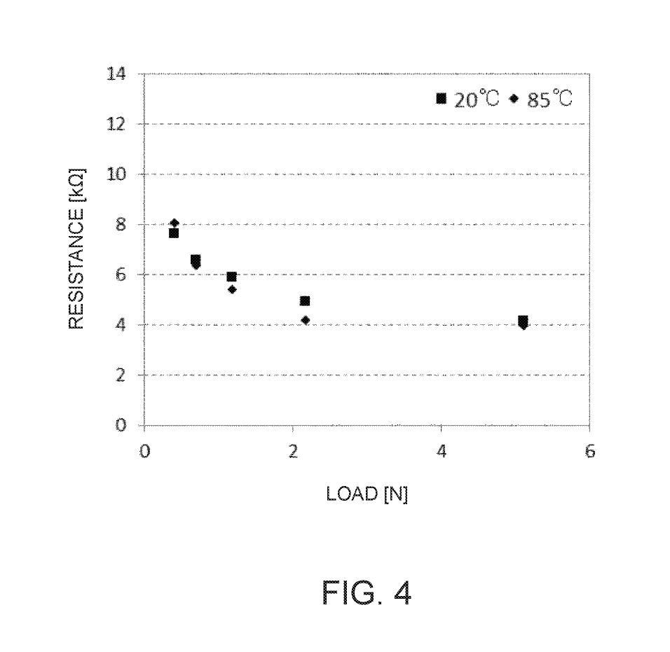

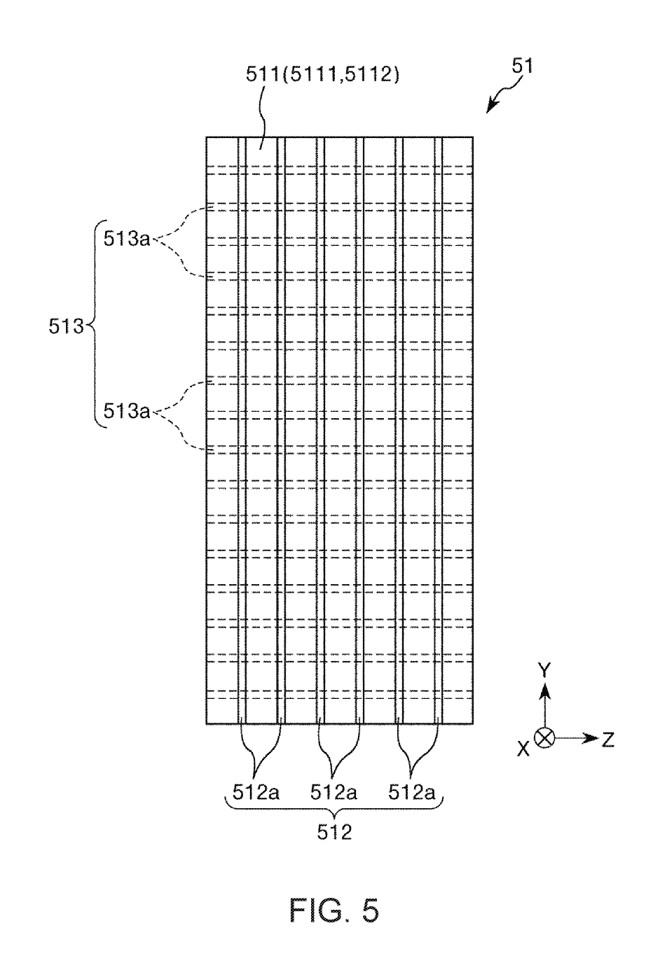

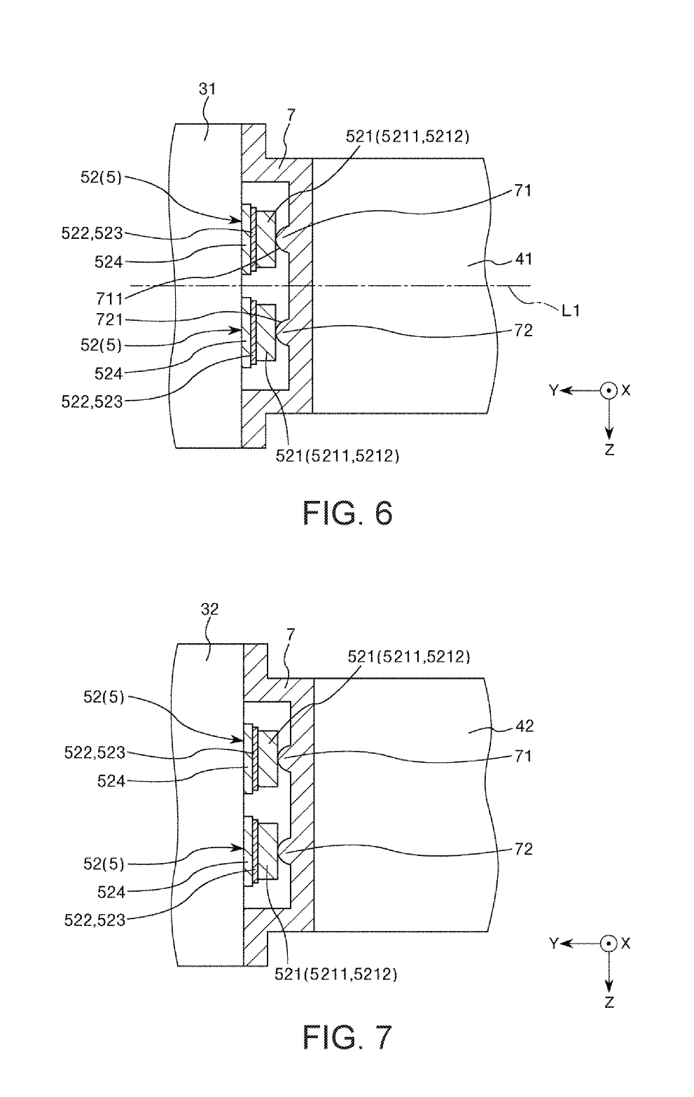

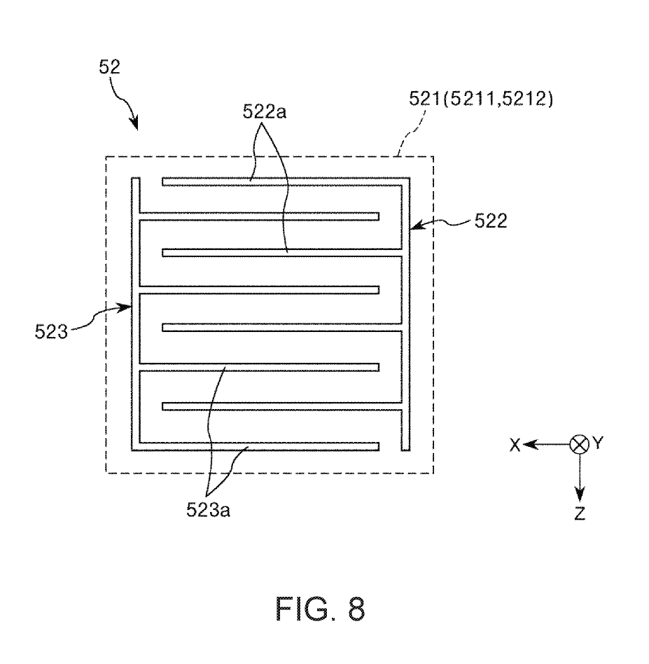

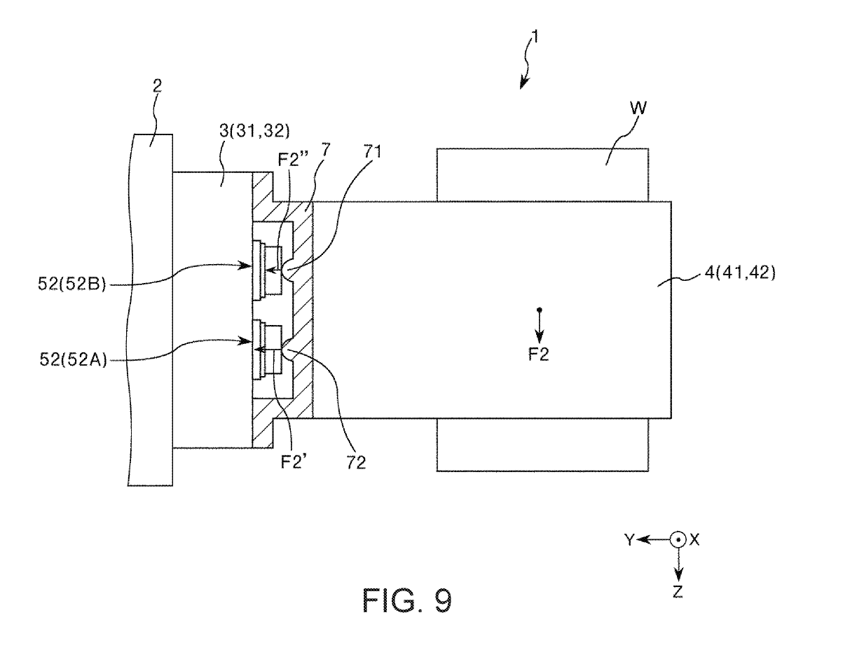

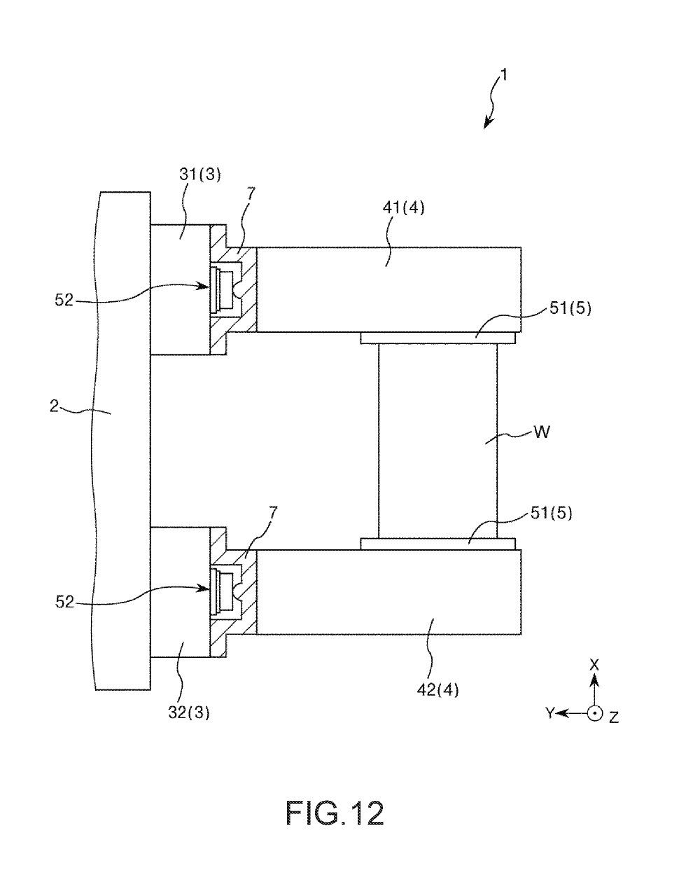

FIG. 1 is a perspective view showing a robot according to the present embodiment. FIG. 2 is a perspective view showing a hand with which the robot shown in FIG. 1 is provided. FIG. 3 is a cross-sectional view showing a first sensor section with which the hand shown in FIG. 2 is provided. FIG. 4 shows graphs illustrating the load-resistance characteristic of the first sensor section. FIG. 5 is a plan view showing the first sensor section. FIGS. 6 and 7 are cross-sectional views showing a second sensor section with which the hand shown in FIG. 2 is provided. FIG. 8 is a plan view showing the second sensor section. FIGS. 9 to 12 each show the hand having grasped a workpiece. In the following description, three axes perpendicular to one another are called an X axis, a Y axis, and a Z axis, as shown in FIG. 2 and other figures, and the directions parallel to the X axis, the Y axis, and the Z axis are called an “X-axis direction,” a “Y-axis direction,” and a “Z-axis direction,” respectively, for ease of description.

A robot 1000 shown in FIG. 1 can deliver, remove, transport, assemble, and otherwise work a precision apparatus and a part (target object) that forms the precision apparatus. The thus functioning robot 1000 includes a robot main body 1400, which includes a base 1100, an arm 1200, which is pivotably connected to the base 1100, and a robot controller 1300, and a hand (robot hand) 1 connected to the arm 1200.

The base 1100 is fixed to a floor or a ceiling. The arm 1200 includes a first arm 1210 pivotably linked to the base 1100, a second arm 1220 pivotably linked to the first arm 1210, a third arm 1230 pivotably linked to the second arm 1220, a fourth arm 1240 pivotably linked to the third arm 1230, a fifth arm 1250 pivotably linked to the fourth arm 1240, and a sixth arm 1260 pivotably linked to the fifth arm 1250. That is, the robot 1000 is what is called a “six-axis robot” having six joints. The hand 1 is connected to the sixth arm 1260. The arms 1210, 1220, 1230, 1240, 1250, and 1260 are driven (caused to pivot) and the hand 1 is driven under the control of the robot controller 1300.

The hand 1 includes a grasper 4, which grasps a workpiece W as a target object, and a sensor section 5, which detects force (reaction force) F1 acting on the grasper 4 when the grasper 4 grasps the workpiece W, as shown in FIG. 2. The sensor section 5 includes a pressure sensitive section 511 (521), which includes a resin 5111 (5211) and carbon nanotubes 5112 (5212), as shown in FIGS. 3 and 6. The configuration described above allows the pressure sensitive section 511 (521) to be formed of a sheet-shaped section, whereby the size (thickness) and weight of the sensor section 5 can be reduced. Further, the pressure sensitive section 511 (521) is unlikely to be affected by temperature, whereby variation in a detection signal due to a change in temperature can be reduced. The sensor sections 5 can therefore be compact and unlikely to be affected by temperature, whereby the robot 1000 can be a reliable robot.

The hand 1 will be described below in detail. The hand 1 includes a base section 2, a movable section 3, which is movable (slidable) relative to the base section 2, the grasper 4, which is connected (fixed) to the movable section 3, and the sensor section 5, as shown in FIG. 2. The hand 1, specifically, the base section 2 is fixed to the sixth arm 1260. The thus configured hand 1 can detect grasping force with which the workpiece W is grasped, the weight of the workpiece W, and other factors with the sensor section 5 and feed back results of the detection. Therefore, not only can the workpiece W be grasped with adequate grasping force, but the workpiece W can be stably grasped. That is, separation (falloff) of the workpiece W from the graspers 4 due to too small grasping force, damage of the workpiece W due to too large grasping force, and other undesirable phenomena can be effectively avoided.

The workpiece W is not limited to a specific one and can, for example, be a semiconductor wafer, such as an integrated circuit, and an electronic device, such as an oscillator and a physical quantity sensor.

The movable section 3 includes a first movable section 31 and a second movable section 32, as shown in FIG. 2. The first movable section 31 and the second movable section 32 are so disposed as to be separate from each other and are movable relative to the base section 2 in the directions in which the movable sections 31 and 32 approach each other or move away from each other. Although not shown, a drive mechanism including a drive source, such as a piezoelectric motor, is provided in the base section 2, and the drive mechanism can move the first movable section 31 and the second movable section 32 along the X-axis direction.

The grasper 4 includes a first grasper 41 and a second grasper 42, as shown in FIG. 2. The first grasper 41 and the second grasper 42 are so disposed as to face each other. The first grasper 41 is fixed to the first movable section 31, and the second grasper 42 is fixed to the second movable section 32. Moving the first and second movable sections 31, 32 therefore allows the first and second graspers 41, 42 to approach each other and move away from each other.

In the present embodiment, the first and second graspers 41, 42 each have a shape linearly extending along the Y-axis direction, but the first and second graspers 41, 42 do not necessarily each have a specific shape and may have, for example, a shape bent (curved) at some midpoint thereof.

The sensor section 5 includes a first sensor section 51, which is disposed between the workpiece W and the grasper 4 (first and second graspers 41, 42) with the grasper 4 grasping the workpiece W (with the workpiece W sandwiched between first and second graspers 41, 42), as shown in FIG. 2. In the configuration in which the first sensor section 51 is disposed in the position described above, the force (reaction force) F1 corresponding to the grasping force F produced by the grasper 4 efficiently (roughly directly) acts on the first sensor section 51, whereby the first sensor section 51 can more precisely detect the grasping force F.

The thus configured first sensor section 51 is provided on each of the first grasper 41 and the second grasper 42.

The first sensor section 51 includes the pressure sensitive section 511 and a pair of electrodes 512 and 513 so provided as to sandwich the pressure sensitive section 511, as shown in FIG. 3. The pressure sensitive section 511 is made of a pressure sensitive, electrically conductive resin. Specifically, the pressure sensitive section 511 includes the resin 5111, which is an insulating resin and serves as a base, and the carbon nanotubes 5112, which are mixed with the resin 5111 and serve as an electrically conductive material. The configuration described above allows the pressure sensitive section 511 to be a sheet-shaped molded section, as shown in FIG. 3, whereby the size (thickness) and weight of the first sensor section 51 can be reduced. In particular, using the carbon nanotubes 5112 as the electrically conductive material (fillers) achieves a linear relationship (close-to-linear relationship) between the force received by the first sensor section 51 and a detection signal outputted from the first sensor section 51. Further, the carbon nanotubes 5112 function as fillers, which increase the mechanical strength of the pressure sensitive section 511 and therefore reduce the amount of permanent strain, whereby the pressure sensitive section 511 has a small amount of age-related deterioration.

Further, in the configuration in which the carbon nanotubes 5112 are used as an electrically conductive material, the pressure sensitive section 511 is unlikely to be affected by temperature, whereby variation (drift) in the detection signal due to a change in temperature can be reduced. The grasping force can therefore be precisely detected with no need, for example, of no excessive temperature correction. This point will be described in detail. The graphs shown in FIG. 4 show the relationship between the force (load) acting on the first sensor section 51 and the value of resistance between the electrodes 512 and 513 in the case where carbon nanotubes are used as the electrically conductive material. As seen from FIG. 4, the load-resistance characteristic at a temperature of 20° C. roughly coincides with the load-resistance characteristic at a temperature of 85° C. Therefore, in the configuration in which the carbon nanotubes 5112 are used as an electrically conductive material, the pressure sensitive section 511 is unlikely to be affected by temperature, whereby variation (drift) in the detection signal due to a change in temperature can be reduced.

The resin 5111 preferably contains a thermoplastic resin. This facilitates kneading of the resin 5111 and the carbon nanotubes 5112, achieves excellent dispersiveness, and provides other advantageous effects, whereby the pressure sensitive section 511 can be readily manufactured. Examples of the thermoplastic resin may include polyethylene, polypropylene, ethylene-vinyl acetate copolymer, or any other polyolefin; modified polyolefin; polyamide; thermoplastic polyimide; aromatic polyester or any other liquid crystal polymer; polyphenylene oxide; polyphenylene sulfide; polycarbonate (PC); polyester carbonate (PPC); polymethyl methacrylate; polyether; polyether ether ketone (PEEK); polyether imide; polyacetal; or a copolymer, a blended body, or a polymer alloy primarily containing any of the above materials, and one of or two or more of the above materials can be mixed with each other and used as the thermoplastic resin. Among them, the resin 5111 preferably contains polycarbonate, which makes the effect described above (ease of kneading) more prominent. Polycarbonate further makes the pressure sensitive section 511 harder, whereby the mechanical strength of the first sensor section 51 can be increased. Moreover, polycarbonate can suppress the amounts of age-related deformation and permanent strain of the pressure sensitive section 511, whereby decrease (variation) in the detection characteristic over time can also be suppressed. Polyester carbonate, polyether ether ketone, and other substances can also provide the same advantageous effect as that provided by the polycarbonate. The hardness of the resin 5111 is not limited to a specific value, but Young's modulus of the resin 5111 is, for example, preferably 1 GPa or greater.

The resin 5111 may contain a thermoset resin. Using a thermoset resin thermally stabilizes the pressure sensitive section 511 (for example, maintains hardness even at temperature as high as about 80° C.), whereby the pressure sensitive section 511 is unlikely to be affected by temperature, and the mechanical strength of the pressure sensitive section 511 can be maintained even at high temperature. Examples of the thermoset resin may include an epoxy resin, a phenol resin, a urea resin, a melamine resin, a polyester (unsaturated polyester) resin, a polyimide resin, a silicone resin, and a polyurethane resin, and one of or two or more of the resins described above can be mixed with each other and used as the thermoset resin.

The thickness of the pressure sensitive section 511 is not limited to a specific value and is preferably greater than or equal to 0.05 mm but smaller than or equal to 5 mm. A thickness that falls within the range allows the function of the pressure sensitive section 511 to be fully provided and achieves a sufficiently thin pressure sensitive section 511. Therefore, the detection characteristic of the first sensor section 51 can be maintained, and the size of the first sensor section 51 can be reduced.

The first sensor section 51 (sensor section 5) has the pair of electrodes 512 and 513, as shown in FIG. 3. The pair of electrodes 512 and 513 are located on opposite sides of the pressure sensitive section 511. That is, the pressure sensitive section 511 is disposed between the pair of electrodes 512 and 513. Specifically, the electrode 512 is disposed on one principal surface (surface facing workpiece W) of the sheet-shaped pressure sensitive section 511, and the electrode 513 is disposed on the other principal surface (surface facing grasper 4). In the configuration in which the electrodes 512 and 513 are so disposed as to sandwich the pressure sensitive section 511 as described above, the electrodes 512 and 513 can be so disposed as not to interfere with each other, whereby the electrodes 512 and 513 can be readily disposed with increased flexibility. The configuration of the first sensor section 51 is therefore simplified.

In the thus configured first sensor section 51, upon reception of the reaction force (force F1) from the workpiece W when the first and second graspers 41, 42 grasp the workpiece W, the electrical resistance between the electrodes 512 and 513 changes in accordance with the magnitude of the force F1. A detection signal representing the force F1 can therefore be detected on the basis of the value of the resistance between the electrodes 512 and 513.

The first sensor section 51 can independently detect the force F1 in a plurality of portions (regions) of the first sensor section 51. That is, the first sensor section 51, which is so disposed as to spread over a predetermined area in a YZ plane, can detect the distribution of the magnitude of the force F1 received within the regions. The detection of the distribution of the magnitude of the force F1 allows acquisition of a variety of pieces of information on the state of the grasped workpiece W, for example, information on which portions of the first and second graspers 41, 42 are grasping the workpiece W and information on the posture of the grasped workpiece W. The state of the grasped workpiece W can therefore be detected in more detail.

The configuration that allows detection of the distribution of the magnitude of the force F1 is not limited to a specific configuration, and the following configuration is employed in the present embodiment: That is, as shown in FIG. 5, the electrode 512 has a plurality of electrode sections 512a, which extend along the Y-axis direction and are so arranged along the Z-axis direction in FIG. 5 as to be separate from each other. Similarly, the electrode 513 has a plurality of electrode sections 513a, which extend along the Z-axis direction and are so arranged along the Y-axis direction as to be separate from each other. In the configuration described above, the region sandwiched between one electrode section 512a and one electrode section 513a forms a unit region that detects the force F1. When the electrode sections are driven in matrix driving, detection signals can be obtained independently of one another from the unit regions, whereby the distribution of the magnitude of the force F1 in the two-dimensional directions (in YZ plane) can be detected. The configuration described above is not necessarily employed in the present embodiment, and a configuration that allows detection of the distribution of the magnitude of the force F1 in a one-dimensional direction (Y-axis direction or Z-axis direction, for example) may be employed.

The first sensor section 51 further includes a first support substrate 514, which supports the electrode 512, and a second support substrate 515, which supports the electrode 513, as shown in FIG. 3. The first support substrate 514 is located on the side opposite the pressure sensitive section 511 with respect to the electrode 512, and the electrode 512 is disposed on the first support substrate 514, specifically, the surface thereof facing the pressure sensitive section 511. Similarly, the second support substrate 514 is located on the side opposite the pressure sensitive section 511 with respect to the electrode 513, and the electrode 513 is disposed on the second support substrate 515, specifically, the surface thereof facing the pressure sensitive section 511. The first support substrate 514 and the second support substrate 515 sandwich the pressure sensitive section 511 so that the electrodes 512 and 513 are in contact with the pressure sensitive section 511. That is, in the present embodiment, the electrodes 512 and 513 are only in contact with the pressure sensitive section 511 but are not bonded (glued) thereto.

Each of the first support substrate 514 and the second support substrate 515 is not limited to a specific substrate and can, for example, be a flexible substrate, a rigid substrate, or any of a variety of other printed substrates. Using a printed substrate as each of the first and second support substrates 514, 515 allows the electrodes 512 and 513 to be readily formed on the first and second support substrates 514, 515. In the present embodiment, the first support substrate 514 is formed of a flexible substrate, and the second support substrate 515 is formed of a rigid substrate. The first sensor section 51 can detect the distribution of the magnitude of the force F1, as described above. To this end, the first support substrate 514, which is located on the side facing the workpiece W (side that receives force F1), is formed of a flexible substrate, so that a portion that receives the force F1 is allowed to partially (locally) undergo bending deformation. On the other hand, in the configuration in which the second support substrate 515 is formed of a rigid substrate, the second support substrate 515 can effectively accept the force F1 (that is, force F1 is unlikely to escape out of pressure sensitive section 511), whereby the force F1 can be more precisely detected.

The configuration of the first sensor section 51 is, however, not limited to the configuration described above. The first and second support substrates 514, 515 may be omitted, and the electrodes 512 and 513 may be formed on the front and rear surfaces of the pressure sensitive section 511, respectively. Still instead, the electrodes 512 and 513 may be located on the same side of the pressure sensitive section 511 (on the side facing workpiece W or grasper 4).

The first sensor sections 51 have been described above. In the present embodiment, to prevent the first sensor sections 51 from coming into contact with the workpiece W and protect the workpiece W and the first sensor sections 51, protective layers 6, which cover the first sensor sections 51, are provided, as shown in FIG. 3. The protective layers 6 are each an insulating layer, which prevents a short circuit from occurring in the corresponding first sensor section 51. The constituent material of the thus configured protective layers 6 is not limited to a specific material and can be any relatively soft material that can be elastically deformed (that is, any material that does not prevent detection of pressure distribution described above), for example, a urethane-based resin, a silicone-based resin, or any of a variety of other resin materials; an acrylic rubber, a silicone-based rubber, a butadiene-based rubber, a styrene-based rubber, or any of a variety of other rubber materials; and a variety of thermoplastic elastomers. Using any of the materials described above allows a sufficient protection function to be provided without inhibition of transmission of the force F1 to the first sensor sections 51.

The sensor section 5 further includes second sensor sections 52, which are disposed between the movable section 3 and the grasper 4, as well as the first sensor sections 51 described above, as shown in FIG. 2. Since force according to the force F1 is also transmitted to other locations, such as the locations where the second sensor sections 52 are disposed, the second sensor sections 52 can also detect the force according to the force F1. The second sensor sections 52 can therefore assist a result of the detection performed by the first sensor sections 51, whereby the force F1 can be more accurately detected. Further, the second sensor sections 52 allow detection of the weight of the workpiece Wand sliding motion thereof, as will be described later. Feeding back a result of the detection allows the hand 1 to be capable of grasping the workpiece W in a more stable manner.

The second sensor sections 52 are provided between the first grasper 41 and the first movable section 31 and between the second grasper 42 and the second movable section 32, as shown in FIG. 2. The second sensor section 52 located between the first grasper 41 and the first movable section 31 is formed of a plurality of second sensor sections 52 arranged along the Z-axis direction perpendicular to the movement direction of the first movable section 31 (X-axis direction), as shown in FIG. 6. Similarly, the second sensor section 52 located between the second grasper 42 and the second movable section 32 is formed of a plurality of second sensor sections 52 arranged along the Z-axis direction perpendicular to the movement direction of the second movable section 32 (X-axis direction), as shown in FIG. 7. In the configuration in which the plurality of second sensor sections 52 are arranged in the Z-axis direction as described above, the weight of the workpiece W and sliding motion thereof can be more precisely detected.

The second sensor sections 52 located between the first grasper 41 and the first movable section 31 and the second sensor sections 52 located between the second grasper 42 and the second movable section 32 have the same configuration. Therefore, the second sensor sections 52 located between the first grasper 41 and the first movable section 31 will be representatively described below, and the second sensor sections 52 located between the second grasper 42 and the second movable section 32 will not be described.

The second sensor sections 52 located between the first grasper 41 and the first movable section 31 are formed of two second sensor sections 52 arranged along the Z-axis direction perpendicular to the direction in which the first movable section 31 moves (X-axis direction) and the direction in which the first grasper 41 extends (Y-axis direction). Further, in a plan view viewed along the movement direction (X-axis direction), assuming that a central imaginary line L1, which halves the first grasper 41 in the Z-axis direction is set, the central imaginary line L1 is located between the two second sensor sections 52. That is, one of the second sensor sections 52 is located on one side of the central imaginary line L1, and the other second sensor section 52 is located on the other side of the central imaginary line L1. The number of second sensor sections 52 located between the first grasper 41 and the first movable section 31 is not limited a specific number and may be one or three or greater.

The second sensor sections 52 each include a pressure sensitive section 521 and a pair of electrodes 522 and 523. The pressure sensitive section 521 is made of a pressure sensitive, electrically conductive resin. Specifically, the pressure sensitive section 521 includes an insulating resin 5211, which serves as a base, and carbon nanotubes 5212, which serve as an electrically conductive material mixed with the resin 5211, which means that the pressure sensitive section 521 has the same configuration as that of the pressure sensitive section 511 of each of the first sensor sections 51 described above. The configuration described above allows the pressure sensitive section 521 to be a sheet-shaped section, as in the case of the pressure sensitive section 511 described above, whereby the size (thickness) and weight of the second sensor sections 52 can be reduced. Further, the pressure sensitive section 521 is unlikely to be affected by temperature, whereby a change (variation) in the detection signal due to a change in temperature can be reduced.

The second sensor sections 52 (sensor section 5) each have the pair of electrodes 522 and 523, as shown in FIG. 6. The pair of electrodes 522 and 523 are located on the same side of the pressure sensitive section 521. That is, the pair of electrodes 522 and 523 are located on the same principal surface out of the two principal surfaces located on the front and rear sides of the pressure sensitive section 521 in the thickness direction thereof. Specifically, the electrodes 522 and 523 are both located on the pressure sensitive section 521, specifically, on the side thereof facing the first movable section 31. In the configuration in which the electrodes 522 and 523 are disposed on the same principal surface of the pressure sensitive section 521 as described above, the second sensor sections 52 can be thinner, for example, than the first sensor sections 51 described above. Further, the electrodes 522 and 523 can both be formed on a support substrate 524, as will be described later. The configuration of the second sensor sections 52 can therefore be simpler than in a case where the electrodes are formed on separate support substrates, as in the case of the first sensor sections 51 described above. In particular, in the configuration in which the electrodes 522 and 523 are disposed on the pressure sensitive section 521, specifically, on the side thereof facing the first movable section 31, as in the present embodiment, the electrodes 522 and 523 are readily pulled out toward the base section 2 as compared with a case where the electrodes 522 and 523 are disposed on the pressure sensitive section 521, specifically, on the side thereof facing the grasper 4. Further, the magnitude of pressing force produced by pressing section 71 and 72, which will be described later, and exerted on the electrodes 522 and 523 is reduced, whereby breakage of the electrodes 522 and 523 can be effectively avoided.

The shapes and arrangement of the electrodes 522 and 523 are not limited to specific shapes or arrangement. In the present embodiment, the electrodes 522 and 523 are each a comb-shaped electrode and are so disposed as to interleave with each other, as shown in FIG. 8. That is, the electrodes 522 and 523 are so disposed that electrode fingers 522a of the electrode 522 and electrode fingers 523a of the electrode 523 are alternately arranged. The electrodes 522 and 523 can therefore be so disposed as to spread over the entire region of the pressure sensitive section 521, whereby the second sensor section 52 can reliably detect force acting thereon.

When the thus configured second sensor section 52 receives force in the Y-axis direction (force in thickness direction of pressure sensitive section 521), the electrical resistance between the electrodes 522 and 523 changes in accordance with the magnitude of the received force. Conceivable (speculative) reasons for this are, for example, as follows: the received force deforms the pressure sensitive section 521 and the resistance of the deformed portion changes; and the received force presses the electrodes 522 and 523 against the pressure sensitive section 521 and the contact resistance between the electrodes 522, 523 and the pressure sensitive section 521 in the pressed portion changes. A detection signal representing the received force is therefore obtained on the basis of the resistance between the electrodes 522 and 523.

The second sensor sections 52 each include a support substrate 524, which supports the electrodes 522 and 523, as shown in FIG. 6. The support substrate 524 is located on the side opposite the pressure sensitive section 521 with respect to the electrodes 522 and 523 (side facing first movable section 31), and the electrodes 522 and 523 are disposed on the support substrate 524, specifically, on the side thereof facing the pressure sensitive section 521. The support substrate 524 and the pressure sensitive section 521 sandwich the electrodes 522 and 523 so that the electrodes 522 and 523 are in contact with the pressure sensitive section 521. That is, in the present embodiment, the electrodes 522 and 523 are only in contact with the pressure sensitive section 521 but are not bonded (glued) thereto.

The support substrate 524 is not limited to a specific substrate and can, for example, be a flexible substrate, a rigid substrate, or any of a variety of other printed substrates. Using a printed substrate as the support substrate 524 allows the electrodes 522 and 523 to be readily formed on the support substrate 524. In the present embodiment, the support substrate 524 is formed of a rigid substrate. In the configuration in which the support substrate 524 is formed of a rigid substrate, the support substrate 524 is hard, is therefore unlikely to be deformed, and can effectively accept force acting on the support substrate 524 (that is, force acting on support substrate 524 is unlikely to escape out of pressure sensitive section 521). The second sensor section 52 can therefore more precisely detect the force acting thereon.

The configuration of each of the second sensor sections 52 is, however, not limited to the configuration described above. The support substrate 524 may be omitted, and the electrodes 522 and 523 may be formed on a surface of the pressure sensitive section 521. Still instead, the electrodes 522 and 523 may be located on opposite sides of the pressure sensitive section 521.

The thus configured second sensor sections 52 are provided between the first grasper 41 and the first movable section 31 with the second sensor sections 52 covered with a lid 7, as shown in FIG. 6. The lid 7 is fixed to the first movable section 31, and the first grasper 41 is fixed to the lid 7. That is, the first movable section 31 and the first grasper 41 are linked to each other via the lid 7. The lid 7 is a hard, highly rigid member, and the second sensor sections 52 are pressurized when they are sandwiched between the lid 7 and the first movable section 31. It can therefore be said that the lid 7 functions as a pressurizing section that pressurizes the second sensor sections 52. As described above, pressurizing the second sensor sections 52 improves the responsiveness of the second sensor sections 52, which can then more reliably detect even force having a small magnitude. The second sensor sections 52 can therefore more precisely detect force acting thereon. Pressurizing the second sensor sections 52 further allows them to detect not only force in the direction in which the force compresses the second sensor sections 52 in the thickness direction thereof but force in the direction in which the force stretches the second sensor sections 52 in the thickness direction thereof. The weight and other factors of the workpiece W can therefore be more precisely detected, as will be described later.

The lid 7 is, although not shown, fixed to the first movable section 31 with screw members, such as bolts. According to the configuration described above, adjusting the amount of bolt fastening, for example, allows the magnitude of the pressure acting on the second sensor sections 52 to be readily adjusted. The method for fixing the lid 7 to the first movable section 31 is, however, not limited to a specific method.

The lid 7 includes a protrusion-shaped pressing section 71, which protrudes toward one of the second sensor sections 52 and presses the one second sensor section 52, and a protrusion-shaped pressing section 72, which protrudes toward the other second sensor section 52 and presses the other second sensor section 52, as shown in FIG. 6. The pressing sections 71 and 72 can reliably and stably pressurize the respective second sensor sections 52. The pressing sections 71 and 72 have dome-shaped front end sections 711 and 721, each of which is formed of a curved surface, and the front end sections 711 and 721 are in contact with the second sensor sections 52. In the configuration in which the front end sections 711 and 721, which come into contact with the second sensor sections 52, are each formed of a curved surface, damage of the second sensor sections 52 due to contact with the front end sections 711 and 721 can be avoided. The front end sections 711 and 721 do not each necessarily have a specific shape and may, for example, each be a flat surface.

The constituent material of the lid 7 is not limited to a specific material and may, for example, be iron, nickel, cobalt, aluminum, magnesium, titanium, tungsten, or any of a variety of other metals, an alloy or inter-metal compound containing at least one of the metals described above, or even an oxide, nitride, or carbide of any of the metals.

In the present embodiment, the pressing sections 71 and 72 are in contact with the pressure sensitive section 521, but not necessarily. For example, a protective plate may be provided between the pressing sections 71, 72 and the pressure sensitive sections 521 (provided on the pressure sensitive section 521, specifically the surface thereof facing the pressing sections 71 and 72) so that the pressing sections 71 and 72 are not in direct contact with the pressure sensitive sections 521. Providing the protective plate allows the pressure sensitive sections 521 to be protected from the pressing sections 71 and 72, whereby damage of the pressure sensitive sections 521 can be effectively avoided. The protective plate is preferably a hard, highly rigid member. The constituent material of the protective plate is not limited to a specific material and may, for example, be iron, nickel, cobalt, aluminum, magnesium, titanium, tungsten, or any of a variety of other metals, an alloy or inter-metal compound containing at least one of the metals described above, or even an oxide, nitride, or carbide of any of the metals.

The second sensor sections 52 and the lid 7 have been described above. In a case where the hand 1 grasps the workpiece W with the hand 1 aligned with the horizontal direction (with Z axis aligned with vertical direction), force F2 according to the weight of the workpiece W and oriented in the vertical direction acts on the first and second graspers 41, 42, as shown in FIG. 9. When the force F2 acts on the first and second graspers 41, 42, the first and second graspers 41, 42 and the lid 7 are distorted (bent) around a point in the vicinity of the lid 7, and the second sensor section 52 (52A) located on the lower side in the vertical direction, out of the two sensor sections 52 located on the side facing the base ends of the first and second graspers 41, 42, receives greater pressing force produced by the pressing section 72, which is force F2′ greater than the pressure exerted in advance. On the other hand, the second sensor section 52 (52B) located in on the upper side in the vertical direction receives smaller pressing force produced by the pressing section 71, which is force F2″ smaller than the pressure exerted in advance. The force F2 can therefore be detected from the force F2′ detected by the second sensor section 52A and the force F2″ detected by the second sensor section 52B, and the weight of the workpiece W can further be detected from the force F2. Feeding back the detected weight of the workpiece W allows the hand 1 to more stably grasp the workpiece W. That is, in a case where it is determined that the workpiece W has, for example, a large weight, the first and second graspers 41, 42 are so controlled that the force with which the workpiece W is grasped by the first and second graspers 41, 42 is increased to a value greater than a reference value so that the workpiece W does not fall off the hand 1. Conversely, in a case where it is determined that the workpiece W has a small weight, the first and second graspers 41, 42 are so controlled that the force with which the workpiece W is grasped by the first and second graspers 41, 42 is decreased to a value smaller than the reference value. The grasper 4 can therefore grasp the workpiece W with adequate force that is not too large or too small.

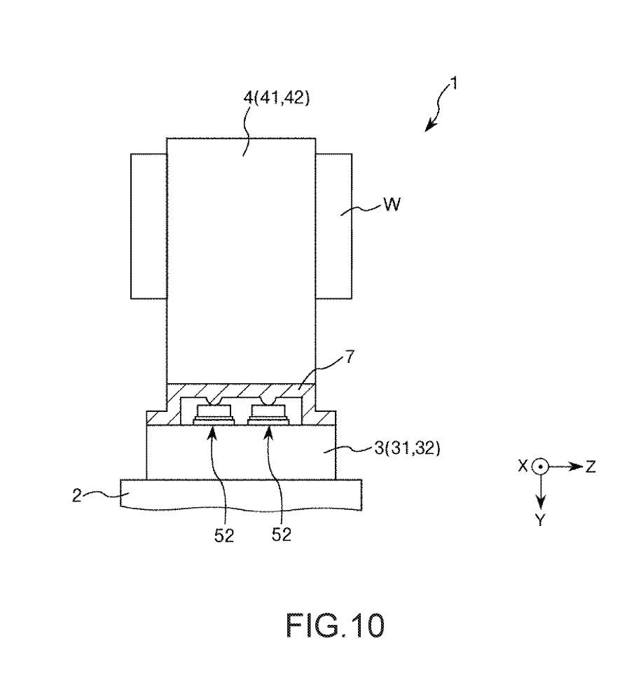

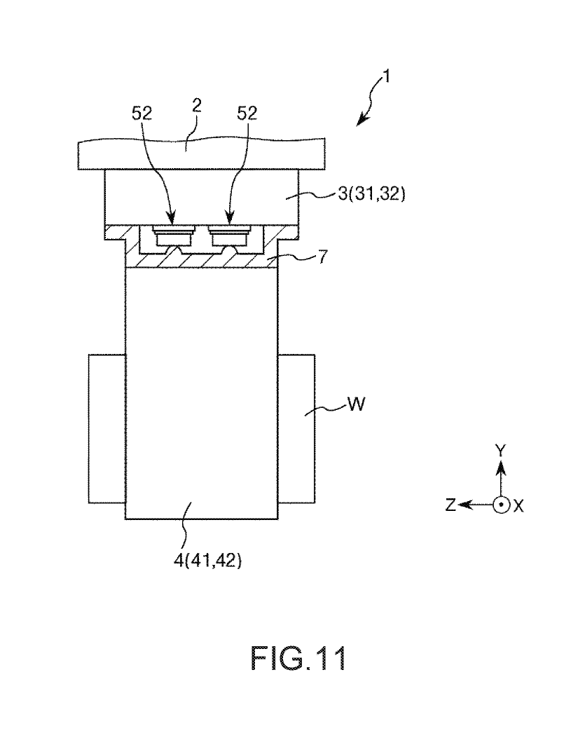

In a case where the workpiece W is grasped with the grasper 4 oriented upward in the vertical direction (with Z axis aligned with horizontal direction), as shown in FIG. 10, the second sensor sections 52 each receive force greater than the pressure exerted in advance. Conversely, in a case where the workpiece W is grasped with the grasper 4 oriented downward in the vertical direction (with Z axis aligned with horizontal direction), as shown in FIG. 11, the second sensor sections 52 each receive force smaller than the pressure exerted in advance. In a case where the workpiece W is grasped with the first and second graspers 41, 42 arranged in the vertical direction, the two second sensor sections 52 facing the first grasper 41 located on the upper side both receive force smaller than the pressure exerted in advance, and the two second sensor sections 52 facing the second grasper 42 located on the lower side both receive force greater than the pressure exerted in advance. As described above, since the combination of the magnitudes of forces acting on the four sensor sections 52 and the magnitude of the pressure exerted in advance changes in accordance with the posture of the hand 1, the posture of the hand can also be detected on the basis of the change in the combination.

Further, for example, in a case where the grasping force produced by grasper 4 is small, and the workpiece W therefore slides relative to the first grasper 41, the sliding motion of the workpiece W causes the first grasper 41 to vibrate (quick sliding vibration having small amplitude). Detecting force produced by the sliding vibration with the two second sensor sections 52 allows detection of the sliding motion of the workpiece W relative to the first grasper 41. Feeding back a result of the detection (increasing grasping force produced by grasper 4, for example) allows the hand 1 to be capable of grasping the workpiece W in a more stable manner.

From another point of view, since the posture (pivotal angle) of each of the arms 1210, 1220, 1230, 1240, 1250, and 1260 is known to the robot controller 1300, the posture of the hand 1 is also sensed on the basis of the postures of the hands, whereby the combination of the posture of the hand 1 with information obtained from the first sensor sections 51 and information obtained from the second sensor sections 52 allows the hand 1 to grasp the workpiece W in more preferable conditions (such as grasping force) irrespective of the posture of the hand 1.

### Second Embodiment

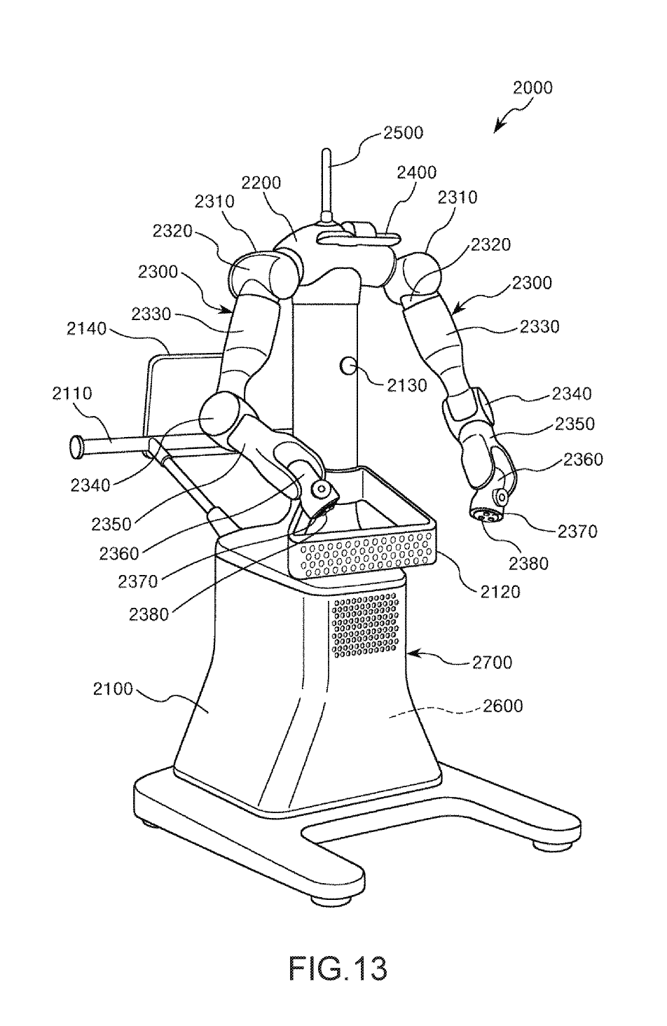

FIG. 13 is a perspective view showing a robot according to the present embodiment of the invention.

The robot according to the present embodiment is the same as the robot according to the first embodiment primarily except that the robot main body is configured differently.

In the following description, the description of the robot according to the present embodiment will be primarily made about differences from the first embodiment described above, and the same items will not be described.

A robot 2000 shown in FIG. 13 includes a robot main body 2700 including a base 2100 as a base mount, a body 2200 connected to the base 2100, a pair of arms 2300 pivotably connected to the body 2200, a stereo camera 2400 and a signal light 2500 provided on the body 2200, and a robot controller 2600, and the hand 1 connected to each of the arms 2300. In FIG. 13, the hands 1 are not shown.

The base 2100 is provided with a plurality of wheels (not shown) that facilitate movement of the robot main body 2700, a lock mechanism (not shown) that locks the wheels, and a handle 2110, which is grasped when the robot main body 2700 is moved. The base 2100 is further provided with a bumper 2120, which comes into contact with a workbench, an emergency stop button 2130 for stopping the robot main body 2700 in case of emergency, an input device 2140, via which instructions and other pieces of information are inputted, and other components.

The body 2200 is liftably and pivotally connected to the base 2100. The arms 2300 each include a first shoulder 2310, which is linked to the body 2200 via a joint mechanism, a second shoulder 2320, which is linked to the first shoulder 2310 via a joint mechanism, an upper arm section 2330, which is linked to the front end of the second shoulder 2320 via a twist mechanism, a first forearm section 2340, which is linked to the front end of the upper arm section 2330 via a joint mechanism, a second forearm section 2350, which is linked to the front end of the first forearm section 2340 via a twist mechanism, a wrist section 2360, which is linked to the front end of the second forearm section 2350 via a joint mechanism, and a linkage section 2370, which is linked to the front end of the wrist section 2360 via a twist mechanism. The linkage section 2370 is provided with a hand section 2380, and the hand 1 is attachable to the hand section 2380.

The present embodiment described above can also provide the same advantageous effects as those provided by the first embodiment described above.

### Third Embodiment

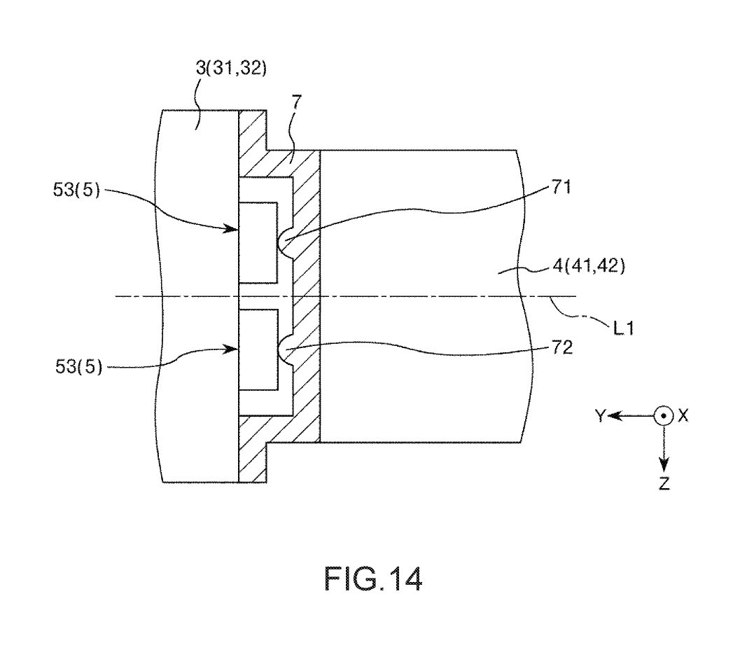

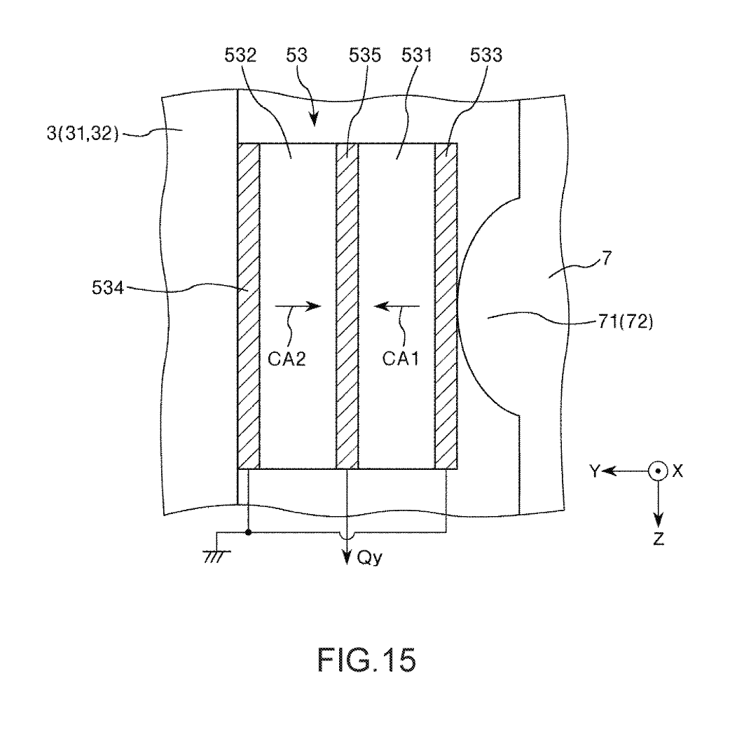

FIG. 14 is a cross-sectional view showing a hand according to the present embodiment. FIG. 15 is a cross-sectional view showing a second sensor section with which the hand shown in FIG. 14 is provided.

The hand according to the present embodiment is the same as the hand of the robot according to the first embodiment primarily except that the second sensor sections are configured differently.

In the following description, the description of the hand according to the present embodiment will be primarily made about differences from the first embodiment described above, and the same items will not be described. In FIG. 14, the same configurations as those in the first embodiment described above have the same reference characters.

The hand 1 according to the present embodiment includes second sensor sections 53, each of which uses a piezoelectric body as the pressure sensitive section, in place of the second sensor sections 52 described in the above first embodiment, as shown in FIG. 14. The second sensor sections 53 have the function of outputting electric charge Qy in accordance with force exerted along the Y-axis direction. The thus configured second sensor sections 53 each include a first piezoelectric body layer 531, which has a crystal axis CA1 oriented in the positive Y-axis direction, a second piezoelectric body layer 532, which has a second crystal axis CA2 oriented in the negative Y-axis direction, a ground electrode 533, which is provided on the first piezoelectric body layer 531, specifically, the side thereof facing the pressing section 71, a ground electrode 534, which is provided on the second piezoelectric body layer 532, specifically, on the side thereof facing the movable section 3, and an output electrode layer 535, which is provided between the first piezoelectric body layer 531 and the second piezoelectric body layer 532 and outputs the electric charge Qy, as shown in FIG. 15. The first piezoelectric body layer 531 and the second piezoelectric body layer 532 can be each formed, for example, of an X-cut quartz plate. The materials of which the first piezoelectric body layer 531 and the second piezoelectric body layer 532 are made are each not limited to a specific material and may, for example, be aluminum nitride (AlN), lithium niobate (LiNbO₃), lithium tantalate (LiTaO₃), lead zirconate titanate (PZT), lithium tetraborate (Li₂B₄O₇), or any other piezoelectric body other than quartz.

The thus configured second sensor sections 53 can also detect the force F2 in the same manner in which the second sensor sections 52 in the first embodiment described above can detect the force F2. In particular, in the present embodiment, since the second sensor sections 53 each use the first piezoelectric body layer 531 and the second piezoelectric body layer 532, which are made of quartz (rigid body), in place of the pressure sensitive sections 521 of the second sensor sections 52 in the first embodiment described above, the mechanical strength of the second sensor sections 53 can be higher than that of the second sensor sections 52.

The present embodiment described above can also provide the same advantageous effects as those provided by the first embodiment described above.

### Fourth Embodiment

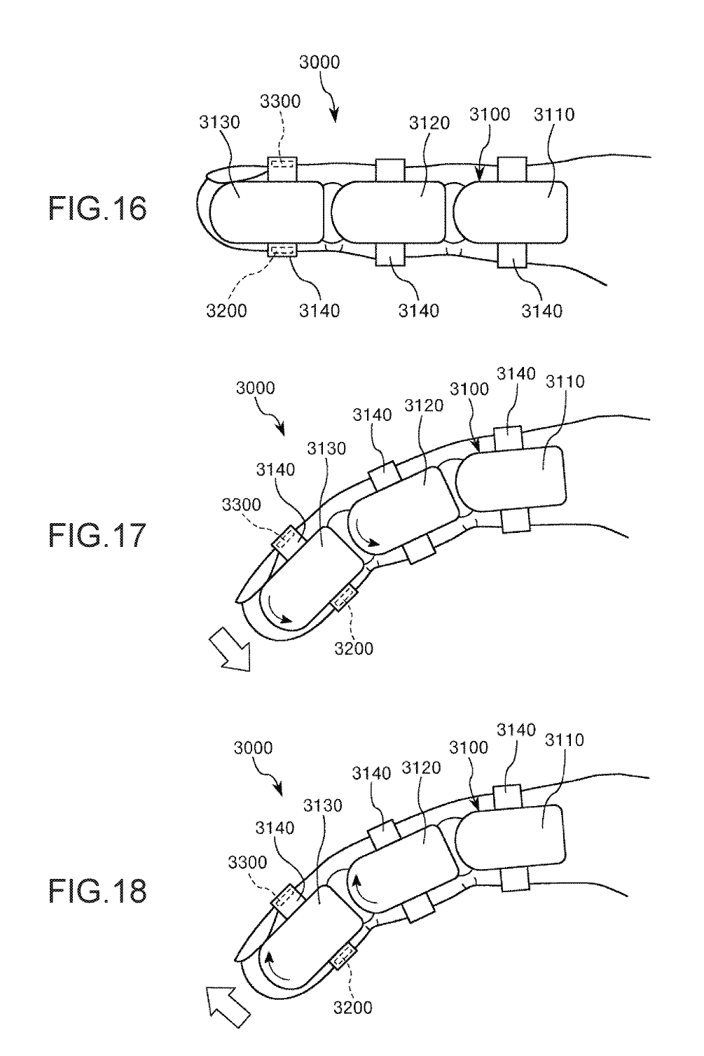

FIG. 16 is a side view showing a hand according to the present embodiment. FIGS. 17 and 18 are side views for describing actions of the hand shown in FIG. 16.

A finger assisting apparatus 3000 as the hand shown in FIG. 16 is an apparatus that is mounted on a person's finger and assists (helps) an action of the finger. In the following sections, a finger assisting apparatus 3000 mounted on a single finger will representatively be described for ease of description. The finger assisting apparatus 3000 may be mounted on any finger or on two or more fingers.

The finger assisting apparatus 3000 includes an apparatus main body 3100 provided on the finger's side surface. The apparatus main body 3100 includes a basal node mount section 3110 mounted on the finger's base node, an intermediate node mount section 3120 linked to the basal node mount section 3110 via a joint mechanism and mounted on the finger's intermediate node, and a distal node mount section 3130 linked to the intermediate node mount section 3120 via a joint mechanism and mounted on the finger's distal node. The basal node mount section 3110, the intermediate node mount section 3120, and the distal node mount section 3130 are each configured to be fixable to the finger's corresponding portion with a soft band 3140. The joint mechanisms each include a built-in drive mechanism including a piezoelectric motor or any other component and allow the intermediate node mount section 3120 to pivot relative to the basal node mount section 3110 and the distal node mount section 3130 to pivot relative to the intermediate node mount section 3120, as a finger's joint allows a similar pivotal motion.

The band 3140 for fixing the distal node mount section 3130 to the finger's distal node is provided with a first sensor section 3200 and a second sensor section 3300. The first sensor section 3200 is so provided as to be in contact with the ball side of the distal node, and the second sensor section 3300 is configured to be in contact with the nail side of the distal node.

The first sensor section 3200 is configured to include a pressure sensitive section including an insulating resin that serves as a base and carbon nanotubes that are mixed with the resin and serve as an electrically conductive material, and a pair of electrodes, as in the case of the first sensor sections 51 and the second sensor sections 52 in the first embodiment described above. The same holds true for the second sensor section 3300.

In the thus configured finger assisting apparatus 3000, when a user attempts to bend the finger, the force in the direction indicated by the arrows acts on the first sensor section 3200, as shown in FIG. 17. Therefore, when the first sensor section 3200 detects the force, the joints mechanisms are so driven as to assist the bending motion of the finger. Conversely, when the user attempts to stretch the finger, the force in the direction indicated by the arrows acts on the second sensor section 3300, as shown in FIG. 18. Therefore, when the second sensor section 3300 detects the force, the joints mechanisms are so driven as to assist the stretching motion of the finger.

According to the configuration described above, the size (thickness) and weight of the first and second sensor sections 3200, 3300 can be reduced. Further, the pressure sensitive sections are unlikely to be affected by temperature, whereby variation in the detection signals due to a change in temperature can be reduced. The first and second sensor sections 3200, 3300 can therefore be compact and unlikely to be affected by temperature, whereby the finger assisting apparatus 3000 can be a reliable apparatus.

The hands and robots according to the embodiments of the invention have been described above with reference to the drawings, but the invention is not limited thereto, and the configuration of each portion in any of the embodiments can be replaced with an arbitrary configuration having the same function. Another arbitrary constituent part may be added to any of the embodiments of the invention, and the embodiments may be combined with each other as appropriate.

A pressing apparatus (electronic part holder), an electronic part transport apparatus, an electronic part test apparatus as the hand according to any of the embodiment and a robot will be described below in detail with reference to preferable embodiments shown in the accompanying drawings.

### Fifth Embodiment

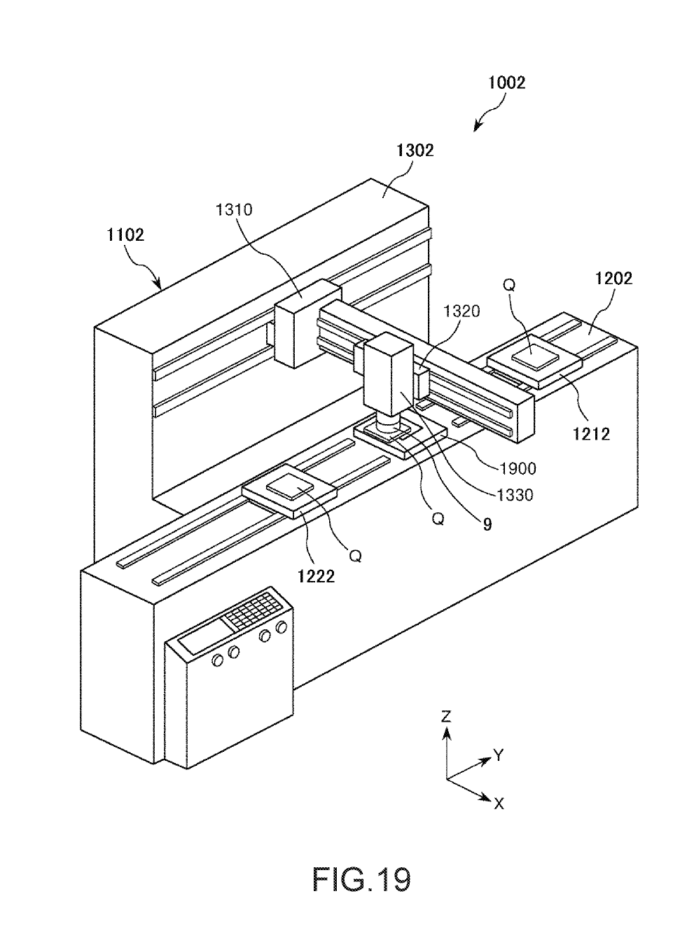

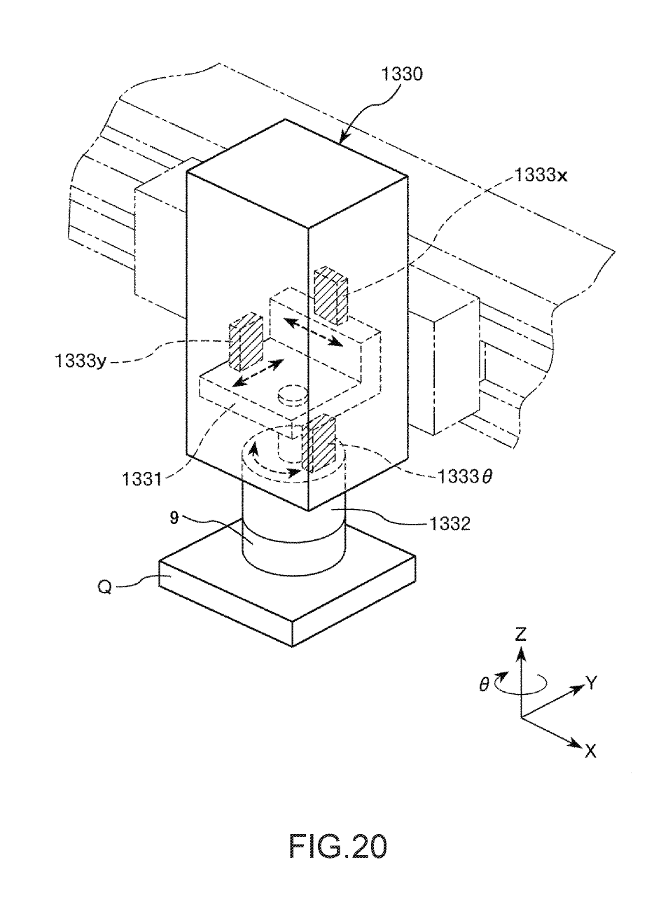

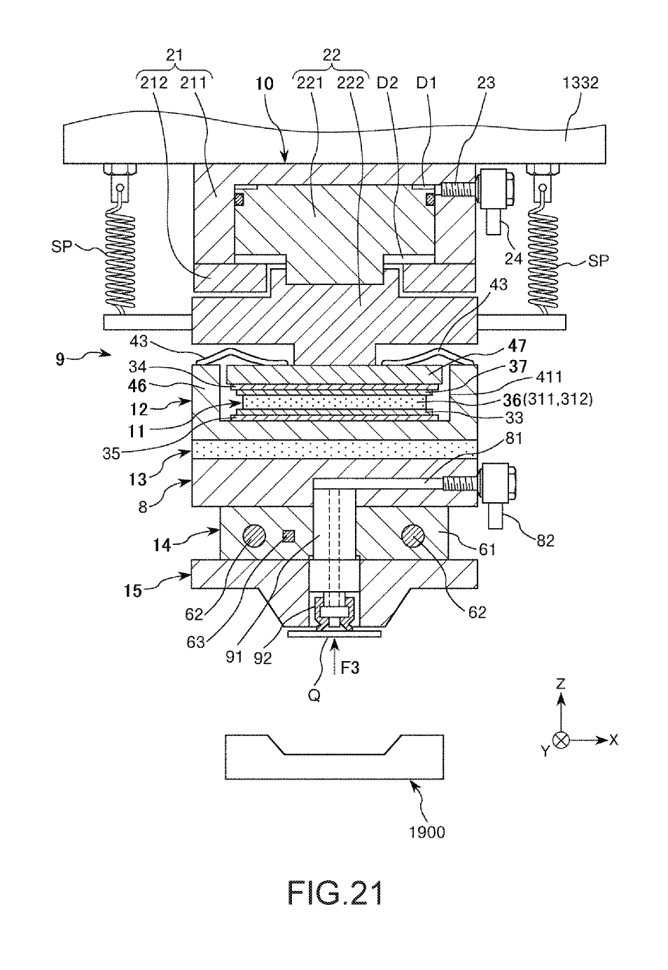

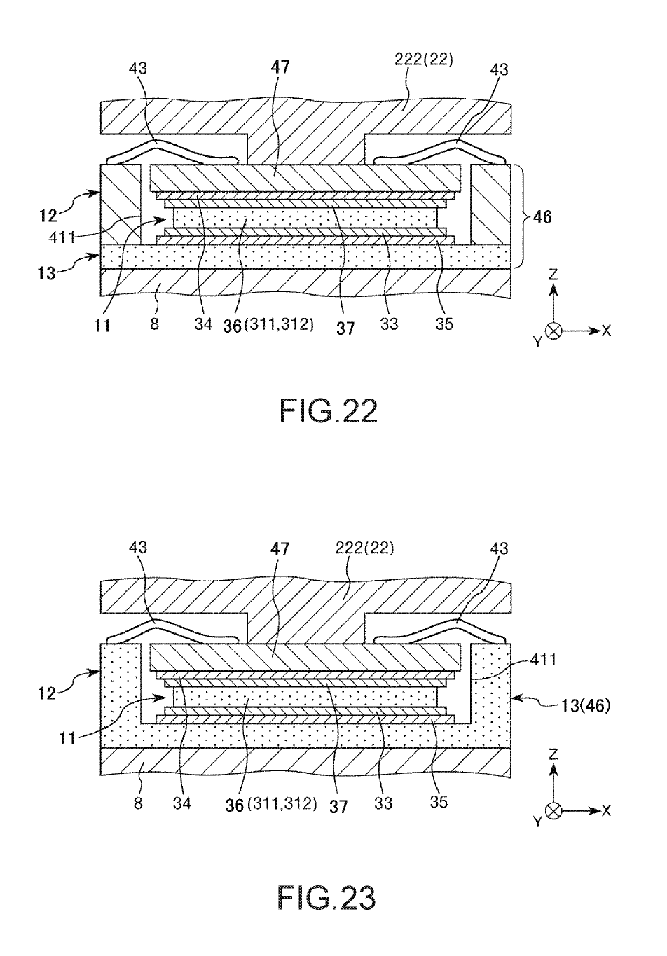

FIG. 19 is a perspective view showing an electronic part test apparatus according to the present embodiment. FIG. 20 is a perspective view showing a Z stage provided in the electronic part test apparatus shown in FIG. 19. FIG. 21 is a cross-sectional view showing an electronic part holder provided in the electronic part test apparatus shown in FIG. 19. FIGS. 22 and 23 are cross-sectional views showing variations of the electronic part holder shown in FIG. 21. In the following description, the upper side in FIG. 21 is also called “above” and the lower side in FIG. 21 is also called “below” for ease of description. In the following sections, three axes perpendicular to one another are called an X axis, a Y axis, and a Z axis, and the directions parallel to the X axis, the Y axis, and the Z axis are called an “X-axis direction,” a “Y-axis direction,” and a “Z-axis direction,” respectively, for ease of description, as shown in FIG. 19 and other Figs.

An electronic part test apparatus 1002 shown in FIG. 19 is an apparatus that tests electric characteristics of an electronic part Q as the target object. The electronic part Q is not limited to a specific part and may, for example, be a semiconductor device or a package thereof; a semiconductor wafer; a CLD, an OLED, an organic EL, or any other display device; a quartz device; a variety of sensors (such as acceleration sensor, angular velocity sensor, pressure sensor, and temperature sensor) ; an inkjet head; and a variety of MEMS devices. In the present specification, the “electronic part” is a wide concept also including a material for forming the electronic part (semiconductor wafer, for example) and a member of part of the electronic part as well as the complete electronic part.

The electronic part test apparatus 1002 includes an electronic part transport apparatus 1102, which transports the electronic part Q, and a test section (socket for test) 1900, which tests electronic characteristics of the electronic part Q, as shown in FIG. 19. The electronic part transport apparatus 1102 includes a base mount 1202 and a support mount 1302, which is disposed on one side of the base mount 1202. The base mount 1202 is provided with an upstream stage (pre-test stage) 1212, on which the electronic part Q to be tested is placed, and a downstream stage (post-test stage) 1222, on which the electronic part Q having been tested is placed. The test section 1900 is provided on the base mount 1202 and between the upstream stage 1212 and the downstream stage 1222.

The support mount 1302 is provided with a Y stage 1310, which is movable in the Y-axis direction relative to the support mount 1302. The Y stage 1310 is provided with an X stage 1320, which is movable in the X-axis direction relative to the Y stage 1310. The X stage 1320 is provided with a Z stage 1330, which is movable in the Z-axis direction relative to the X stage 1320. The Z stage is provided with the electronic part holder (pressing apparatus) 9, which holds the electronic part Q. That is, the electronic part transport apparatus 1102 includes the electronic part holder 9 as the pressing apparatus.

The Z stage 1330 includes a fine adjustment plate 1331, which is movable in the X-axis direction and the Y-axis direction, and a pivotal section 1332, which is pivotable around the Z axis relative to the fine adjustment plate 1331, as shown in FIG. 20. The electronic part holder 9 is attached to the pivotal section 1332. In the Z stage 1330 are built in a drive source 1333x (piezoelectric actuator, for example) for moving the fine adjustment plate 1331 in the X-axis direction, a drive source 1333y (piezoelectric actuator, for example) for moving the fine adjustment plate 1331 in the Y-axis direction, and a drive source 13330 (piezoelectric actuator, for example) for causing the pivotal section 1332 to pivot around the Z axis.

In the thus configured electronic part test apparatus 1002, first of all, the electronic part holder 9 holds the electronic part Q having been transported by the upstream stage 1212 and transports the electronic part Q to the test section 1900. Electric characteristics of the electronic part Q are then tested with the electronic part Q held by the electronic part holder 9 and pressed thereby against the test section 1900. After the test is completed, the electronic part holder 9 transports the electronic part Q to the downstream stage 1222. Repeating the steps described above allows test of a plurality of electronic parts Q.

The electronic part holder 9 as the pressing apparatus will next be described. Although not shown, the electronic part holder 9 is removably fixed to the pivotal section 1332, for example, by screw fastening. The electronic part holder 9 is therefore allowed to readily undergo, for example, maintenance and exchange operation.

The electronic part holder 9 as the pressing apparatus includes, a contact pusher 15, as a pressing section that presses the electronic part Q as the target object, and a sensor section 11, which detects pressing force exerted by the contact pusher 15 on the electronic part Q, as shown in FIG. 21. The sensor section 11 includes a pressure sensitive section 36, which includes a resin 311 and carbon nanotubes 312. According to the configuration described above, the sensor section 11 can detect the pressing force exerted on the electronic part Q, the contact pusher 15 can press the electronic part Q with adequate pressing force. Therefore, breakage of the electronic part Q due to too large pressing force, contact failure between the electronic part Q and the test section 1900 due to too small pressing force, and other types of failure can be effectively avoided, whereby the test section 1900 can appropriately test the electronic part Q. Further, the pressure sensitive section 36 can be a sheet-shaped section, whereby the size (thickness) and weight of the sensor section 11 can be reduced. Moreover, the pressure sensitive section 36 is unlikely to be affected by temperature, whereby variation (drift) in the detection signal due to a change in temperature can be reduced. The sensor section 11 can therefore be compact and unlikely to be affected by temperature. Further, the electronic part transport apparatus 1102 and the electronic part test apparatus 1002 both including the electronic part holder 9 can advantageously receive the effects provided by the electronic part holder 9 and show high reliability.

The thus configured electronic part holder 9 will be described below in detail. The electronic part holder 9 includes an air cylinder 10 as a movement mechanism provided on the lower surface of the pivotal section 1332, the sensor section 11 and a pressurizing section 12 provided at the front end (lower side) of the air cylinder 10, a heat insulating section 13 provided at the front end (lower side) of the pressurizing section 12, a block 8 provided at the front end (lower side) of the heat insulating section 13, a heater 14 as a heating section provided at the front end (lower side) of the block 8, and the contact pusher 15 as the pressing section provided at the front end (lower side) of the heater 14, as shown in FIG. 21.

### Air Cylinder

The electronic part holder 9 includes the air cylinder 10 as the movement mechanism that moves the contact pusher 15, which is the pressing section, in the Z-axis direction (pressing direction). According to the thus configured air cylinder 10, the contact pusher 15 can more reliably press the electronic part Q toward the upstream stage 1211 and the test section 1900. Therefore, to allow the electronic part holder 9 to hold the electronic part Q placed on the upstream stage 1212, the air cylinder 10 is driven to press the contact pusher 15 against the electronic part Q so that the contact pusher 15 (adhesion pad 92, which will be described later) is in intimate contact with the electronic part Q, whereby the electronic part holder 9 can more reliably hold the electronic part Q. To test electric characteristics of the electronic part Q held by the electronic part holder 9, the air cylinder 10 is driven to cause the contact pusher 15 to press the electronic part Q against the test section 1900 so that the electronic part Q is in intimate contact with the test section 1900, whereby satisfactory electrical continuity between the electronic part Q and the test section 1900 is ensured, and the electric characteristics of the electronic part Q can be more reliably tested.

The air cylinder 10 includes a cylinder tube 21 fixed to the lower surface of the pivotal section 1332, as shown in FIG. 21. The cylinder tube 21 has a bottomed, tubular tube main body 211 and a front plate 212, which closes the opening of the tube main body 211, and a piston 22 is so disposed in a cylinder chamber formed by the tube main body 211 and the front plate 212 as to be movable in the Z-axis direction. The piston 22 includes a piston main body 221, which is located in the cylinder chamber, and a linkage block 222, which is fixed to a lower end portion of the piston main body 221 and located outside the cylinder chamber.

The cylinder chamber is partitioned by the piston 22 (piston main body 221) into a first chamber D1 located above the piston 22 and a second chamber D2 located below the piston 22. The piston 22 is lifted upward by springs SP, and in a state in which the air cylinder 10 is not actuated, the piston 22 is located in the position where the upper surface (upper end) thereof is in contact with the bottom surface of the tube main body 211 (this position is hereinafter also referred to as a “highest end position”).

An air introduction port 23, which leads to the first chamber D1, is formed in the cylinder tube 21, and a linkage port 24 is connected to the air introduction port 23, as shown in FIG. 21. An electro-pneumatic regulator that is not shown is linked to the linkage port 24, and when the electro-pneumatic regulator supplies air into the first chamber D1, the pressure of the air moves the piston 22 from the highest end position downward against the elastic force of the springs SP. Setting the pressure in the first chamber D1 at a predetermined value allows the electronic part Q placed in the test section 1900 to be pressed with adequate pressure. Therefore, the electrical continuity between the electronic part Q and the test section 1900 can be reliably achieved, and breakage of the electronic part Q can be avoided.

The air cylinder 10 as the movement mechanism has been described above. The configuration of the movement mechanism is not limited to a specific mechanism and can be any mechanism capable of moving the contact pusher 15 in the Z-axis direction. For example, a drive source, such as a piezoelectric motor, may be used to move the contact pusher 15 in the Z-axis direction.

### Sensor Section

The electronic part holder 9 includes the sensor section 11, which detects the pressing force exerted by the contact pusher 15 on the electronic part Q, as shown in FIG. 21. The sensor section 11 is located on the side opposite the electronic part Q, which is the target object, with respect to the contact pusher 15 (side opposite side toward which electronic part Q is pressed). That is, in the state in which the electronic part holder 9 holds the electronic part Q, the sensor section 11 is located on the side opposite the electronic part Q with respect to the contact pusher 15. The arrangement described above allows the number of members interposed between the contact pusher 15 and the electronic part Q to be reduced and the contact pusher 15 to efficiently press the electronic part Q.

The sensor section 11 includes the pressure sensitive section 36 and a pair of electrodes 37 and 33 so disposed as to sandwich the pressure sensitive section 36, as shown in FIG. 21.

The pressure sensitive section 36 is made of a pressure sensitive, electrically conductive material. Specifically, the pressure sensitive section 36 includes an insulating resin 311, which serves as a base, and carbon nanotubes 312, which are mixed with the resin 311 and serve as an electrically conductive material (fillers). The configuration described above allows the pressure sensitive section 36 to be a sheet-shaped section, as shown in FIG. 21, whereby the size (thickness) and weight of the sensor section 11 can be reduced. In particular, using the carbon nanotubes 312 as the electrically conductive material achieves a linear relationship (close-to-linear relationship) between the force received by the sensor section 11 and the detection signal outputted from the first sensor section 11. Further, the carbon nanotubes 312 function as fillers, which increase the mechanical strength of the pressure sensitive section 36 and therefore reduce the amount of permanent strain, whereby the pressure sensitive section 36 has a small amount of age-related deterioration.

Further, in the configuration in which the carbon nanotubes 312 are used as an electrically conductive material, the pressure sensitive section 36 is unlikely to be affected by temperature, whereby a change (variation) in the detection signal due to a change in temperature can be reduced. The pressing force can therefore be precisely detected with no need, for example, of excessive temperature correction (without relying on correction circuit). This point will be described in detail. The graphs shown in FIG. 4 show the relationship between the force (load) acting on the first sensor section 11 and the value of resistance between the electrodes 37 and 33 in the case where the carbon nanotubes are used as the electrically conductive material. As seen from the graphs, the load-resistance characteristic at a temperature of 20° C. roughly coincides with the load-resistance characteristic at a temperature of 85° C. Therefore, in the configuration in which the carbon nanotubes 312 are used as an electrically conductive material, the pressure sensitive section 36 is unlikely to be affected by temperature, whereby variation (drift) in the detection signal due to a change in temperature can be reduced. In particular, in the present embodiment, in which the heater 14 is provided, the heat produced by the heater 14 is transferred to the sensor section 11, and the temperature of the sensor section 11 therefore changes in some cases. The configuration of the sensor section 11 described above can therefore provide the effect thereof in a notable manner.

The resin 311 preferably contains a thermoplastic resin. This facilitates kneading of the resin 311 and the carbon nanotubes 312, achieves excellent dispersiveness, and provides other advantageous effects, whereby the pressure sensitive section 36 can be readily manufactured. Examples of the thermoplastic resin may include polyethylene, polypropylene, ethylene-vinyl acetate copolymer, or any other polyolefin; modified polyolefin; polyamide; thermoplastic polyimide; aromatic polyester or any other liquid crystal polymer; polyphenylene oxide; polyphenylene sulfide; polycarbonate (PC); polyester carbonate (PPC); polymethyl methacrylate; polyether; polyether ether ketone (PEEK); polyether imide; polyacetal; or a copolymer, a blended body, or a polymer alloy primarily containing any of the materials described above, and one of or two or more of the above materials can be mixed with each other and used as the thermoplastic resin. Among them, the resin 311 preferably contains polycarbonate, which makes the effect described above (ease of kneading) more prominent. Polycarbonate further makes the resin 311 harder, whereby the mechanical strength of the sensor section 11 can be increased. Moreover, polycarbonate can suppress the amounts of age-related deformation and permanent strain of the resin 311, whereby decrease in the detection characteristic over time can be suppressed. Polyester carbonate, polyether ether ketone, and other substances can also provide the same advantageous effect as that provided by the polycarbonate. The hardness of the resin 311 is not limited to a specific value, but Young's modulus of the resin 311 is, for example, preferably 1 GPa or greater.

The resin 311 may contain a thermoset resin. Using a thermoset resin thermally stabilizes the pressure sensitive section 36 (for example, maintains sufficient hardness even at temperature as high as 80° C.), whereby the pressure sensitive section 36 is unlikely to be affected by temperature, and the mechanical strength of the pressure sensitive section 36 can be maintained even at high temperature. Examples of the thermoset resin may include an epoxy resin, a phenol resin, a urea resin, a melamine resin, a polyester (unsaturated polyester) resin, a polyimide resin, a silicone resin, and a polyurethane resin, and one of or two or more of the resins described above can be mixed with each other and used as the thermoset resin.

The thickness of the pressure sensitive section 36 is not limited to a specific value and is preferably greater than or equal to 0.05 mm but smaller than or equal to 5 mm. A thickness that falls within the range allows the function of the pressure sensitive section 36 to be fully provided and achieves a sufficiently thin pressure sensitive section 36. Therefore, the detection characteristic of the sensor section 11 can be maintained, and the size (weight) of the sensor section 11 can be reduced.

The sensor section 11 has the pair of electrodes 37 and 33, as shown in FIG. 21. The pair of electrodes 37 and 33 are located on opposite sides of the pressure sensitive section 36. Specifically, the electrode 37 is disposed above the pressure sensitive section 36 (on the side facing the air cylinder 10), and the electrode 33 is disposed below the pressure sensitive section 36 (on the side facing the contact pusher 15). In the configuration in which the electrodes 37 and 33 are so disposed as to sandwich the pressure sensitive section 36, as described above, the electrodes 37 and 33 can be so disposed as not to interfere with each other, whereby the electrodes 37 and 33 can be readily disposed with increased flexibility. The configuration of the sensor section 11 is therefore simplified. The electrodes 37 and 33 do not each necessarily have a specific shape.

In the thus configured sensor section 11, when it receives force F3 (reaction force from electronic part Q) produced when the contact pusher 15 presses the electronic part Q, the electrical resistance between the electrodes 37 and 33 changes in accordance with the magnitude of the force F3. The force F3 can therefore be detected on the basis of the value of the resistance between the electrodes 37 and 33.

The sensor section 11 further includes a support substrate 34, which supports the electrode 37, and a support substrate 35, which supports the electrode 33. The support substrate 34 is located above the electrode 37, and the electrode 37 is formed on the lower surface of the support substrate 34. On the other hand, the support substrate 35 is located below the electrode 33, and the electrode 33 is formed on the upper surface of the support substrate 35. The support substrates 34 and 35 sandwich the pressure sensitive section 36 so that the electrodes 37 and 33 are in contact with the pressure sensitive section 36. That is, in the present embodiment, the electrodes 37 and 33 are only in contact with the pressure sensitive section 36 but are not bonded (glued) thereto.

The support substrates 34 and 35 are each not limited to a specific substrate and can, for example, be a flexible substrate, a rigid substrate, or any of a variety of other printed substrates. Using a printed substrate as each of the support substrates 34 and 35 allows the electrodes 37 and 33 to be readily formed on the support substrates 34 and 35.

The sensor section 11 has been described above. The configuration of the sensor section 11 is, however, not limited to the configuration described above. For example, the support substrates 34 and 35 may be omitted, and the electrodes 37 and 33 maybe formed (disposed) on the front and rear surfaces of the pressure sensitive section 36, respectively.

### Pressurizing Section

The electronic part holder 9 includes the pressurizing section 12, which pressurizes the sensor section 11 in the Z-axis direction in a state in which the contact pusher 15 does not press the electronic part Q, as shown in FIG. 21. Pressurizing the sensor section 11 as described above allows the sensor section 11 to respond quickly when the force F3 acts on the sensor section 11, whereby the detection characteristic of the sensor section 11 is improved; for example, even force F3 having a small magnitude can be reliably detected. The sensor section 11 can therefore more precisely detect the force F3. Pressurizing the sensor section 11 further allows it to detect not only force in the direction in which the force compresses the sensor section 11 in the thickness direction thereof (upward force in Z-axis direction) but force in the direction in which the force stretches the sensor section 11 in the thickness direction thereof (downward force in Z-axis direction). The sensor section 11 can therefore sense not only the pressing force produced by the contact pusher 15 but, for example, a state in which the electronic part Q is caught by the upstream stage 1212 or the test section 1900 when the electronic part Q is transported from the upstream stage 1212 or the test section 1900. Breakage of the upstream stage 1212, the test section 1900, the electronic part Q, and other components can therefore be avoided.

The thus configured pressurizing section 12 includes a base 46, which has a recess 411, which opens upward, a lid 47, which is provided in the recess 411, and an urging section 43, which urges the base 46 upward (toward lid 47), as shown in FIG. 21. The urging section 43 is formed of an elastically deformed spring member fixed to the base 46 and is in contact with the lid 47. The thus configured pressurizing section 12 allows the sensor section 11 to be disposed in the recess 411 and sandwiched between the lid 47 and the base 46 to pressurize the sensor section 11 in the Z-axis direction. Specifically, the support substrate 34 is fixed to the lower surface of the lid 47, the support substrate 35 is fixed to the bottom surface of the recess 411, and the pressure sensitive section 36 is sandwiched between the support substrates 34 and 35. The urging force produced by the urging member 43 urges the base 46 upward, whereby the sensor section 11 is pressurized in the Z-axis direction.

The constituent material of the base 46 and the lid 47 is not limited to a specific material and may, for example, be iron, nickel, cobalt, aluminum, magnesium, titanium, tungsten, or any of a variety of other metals, an alloy or inter-metal compound containing at least one of the metals described above, or even an oxide, nitride, or carbide of any of the metals.

The pressurizing section 12 has been described above. The pressurizing section 12 does not necessarily have a specific configuration and may have any configuration that can pressurize the sensor section 11.

### Heater

The electronic part holder 9 includes the heater 14, which is located on the side opposite the electronic part Q, which is the target object, with respect to the contact pusher (side opposite side toward which electronic part Q is pressed) and serves as a heating section that heats the contact pusher 15, as shown in FIG. 21. Providing the heater 14 as described above allows the contact pusher 15 heated by the heater 14 to heat the electronic part Q. The test section 1900 can therefore test electric characteristics of the electronic part Q at high temperature. The convenience of the electronic part test apparatus 1002 (electronic part transport apparatus 1102) is therefore improved.

In particular, in the present embodiment, the heater 14 is located below the sensor section 11 described above (in a position shifted toward contact pusher 15). In other words, the heater 14 is located between the sensor section 11 and the contact pusher 15. The number of members interposed between the heater 14 and the contact pusher 15 can therefore be reduced, whereby the heater 14 and the contact pusher 15 can be so disposed as to be closer to each other. The heat produced by the heater 14 can therefore be efficiently transferred to the contact pusher 15, and the electronic part Q held by the contact pusher 15 can be efficiently heated.

The thus configured heater 14 includes a heater block 61 and a rod-shaped heater element (heating element) 62 buried in the heater block 61, as shown in FIG. 21. The heater block 61 can be heated to a predetermined temperature by driving the heater element 62 under the control of a controller that is not shown.

The heater block 61 is hard and has high thermal conductivity. The constituent material of the heater block 61 is not limited to a specific material and may, for example, be iron, nickel, cobalt, gold, platinum, silver, copper, aluminum, magnesium, titanium, tungsten, or any of a variety of other metals, an alloy or inter-metal compound containing at least one of the metals described above, or even an oxide, nitride, or carbide of any of the metals.

The heater element 62 is not limited to a specific one and can, for example, be any of a variety of ceramic heaters, such as an alumina heater, an aluminum nitride heater, a silicon nitride heater, and an arsenic nitride heater, or any of a variety of cartridge heaters using a heating wire, such as a nichrome wire. The heater element 62 is not necessarily a rod-shaped element and may, for example, be a planar element.

A temperature sensor 63 is buried in the heater block 61, as shown in FIG. 21. The temperature sensor 63 detects the temperature of the heater block 61 and can therefore indirectly detect the temperature of the electronic part Q. The temperature sensor 63 is not limited to a specific sensor and can, for example, be a platinum sensor, a thermocouple, a thermistor. In a case where the electronic part Q has a built-in temperature sensor, such as a thermal diode, the temperature sensor 63 may be omitted, and the temperature sensor in the electronic part Q may detect the temperature of the electronic part Q.

The heater 14 has been described above. The heater 14 does not necessarily have a specific configuration and may have any configuration that can heat the electronic part Q. Further, for example, in a case where the electronic part Q does not need to be tested in a high-temperature environment or in a case where a heater is built in the electronic part test apparatus 1002, the heater 14 may be omitted.

### Heat Insulting Section

The electronic part holder 9 includes the heat insulating section 13, which is disposed between the sensor section 11 and the heater 14, as shown in FIG. 21. The thus configured heat insulating section 13 is a block-shaped section, has an upper surface fixed to the pressurizing section 12, and has a lower surface fixed to the heater block 61. As a result, the heat produced by the heater 14 is unlikely to be transferred to the sensor section 11, whereby an excessive increase in the temperature of the sensor section 11 is avoided. Further, since the heat insulating section 13 suppresses upward heat transfer, the heat can be efficiently transferred to the contact pusher 15 located below the heater 14. The electronic part Q can therefore be efficiently heated.

The heat insulating section 13 is hard and has high thermal resistance. The heat insulating section 13 is not necessarily made of a specific material and can be made, for example, of a foamed plastic material, such as hard polyurethane foam.

The heat insulating section 13 has been described above. The heat insulating section 13 does not necessarily have a specific configuration and may have any configuration that can suppress heat transfer to the sensor section 11. Further, in a case where the structure of the electronic part holder 9 does now allows excessive heat to be transferred to the sensor section 11, for example, in the case where the heater 14 is omitted, the heat insulating section 13 may be omitted. For example, in the present embodiment, the heat insulating section 13 and the base 46 of the pressurizing section 12 are formed of members separate from each other. Instead, the heat insulating section 13 may also serve as part (bottom) or entirety of the base 46, as shown in FIGS. 22 and 23. That is, the sensor section 11 may be disposed on the upper surface of the heat insulating section 13. The number of parts can therefore be reduced, whereby the size of the electronic part holder 9 can be reduced.

### Block

The electronic part holder 9 includes the block 8 disposed between the heat insulating section 13 and the heater 14, as shown in FIG. 21. A vacuum guide path 81 is formed in the block 8 and opens through a central portion of the lower surface of the block 8 and a side surface thereof. A linkage port 82 is attached to the vacuum guide path 81. Further, a gas sucking section and a gas supplying section that are not shown are connected to the linkage port 82.

The constituent material of the block 8 is not limited to a specific material and may, for example, be iron, nickel, cobalt, gold, platinum, silver, copper, aluminum, magnesium, titanium, tungsten, or any of a variety of other metals, an alloy or inter-metal compound containing at least one of the metals described above, or even an oxide, nitride, or carbide of the metals described above.

### Contact Pusher

The electronic part holder 9 includes the contact pusher 15 disposed below the heater 14, as shown in FIG. 21. The contact pusher 15 is a portion that comes into contact with the electronic part Q and presses the electronic part Q toward the upstream stage 1212 and the test section 1900. The thus configured contact pusher 15 is hard and has high thermal conductivity. The constituent material of the contact pusher 15 is not limited to a specific material and may, for example, be iron, nickel, cobalt, gold, platinum, silver, copper, aluminum, magnesium, titanium, tungsten, or any of a variety of other metals, an alloy or inter-metal compound containing at least one of the metals described above, or even an oxide, nitride, or carbide of the metals described above.

The contact pusher 15 has been described above. The contact pusher 15 does not necessarily have a specific configuration and may have any configuration that can press the electronic part Q.

An accommodation hole that passes through the heater block 61 and the contact pusher 15 and leads to the vacuum guide path 81 is formed in central portions of the heater block 61 and the contact pusher 15, and a sucking tube 91 is disposed in the accommodation hole. Further, an adhesion pad (adhesion hole) 92 is provided in a front end portion of the sucking tube 91. Therefore, the gas sucking section sucks air through the linkage port 82 so that a negative pressure state is achieved in the sucking tube 91, whereby the adhesion pad 92 adheres to the electronic part Q and can hold it. Conversely, the gas supply section supplies air through the linkage port 82 so that the negative pressure state in the sucking tube 91 is eliminated, whereby the electronic part Q that adheres to the adhesion pad 92 and held thereby can be released.

### Sixth Embodiment

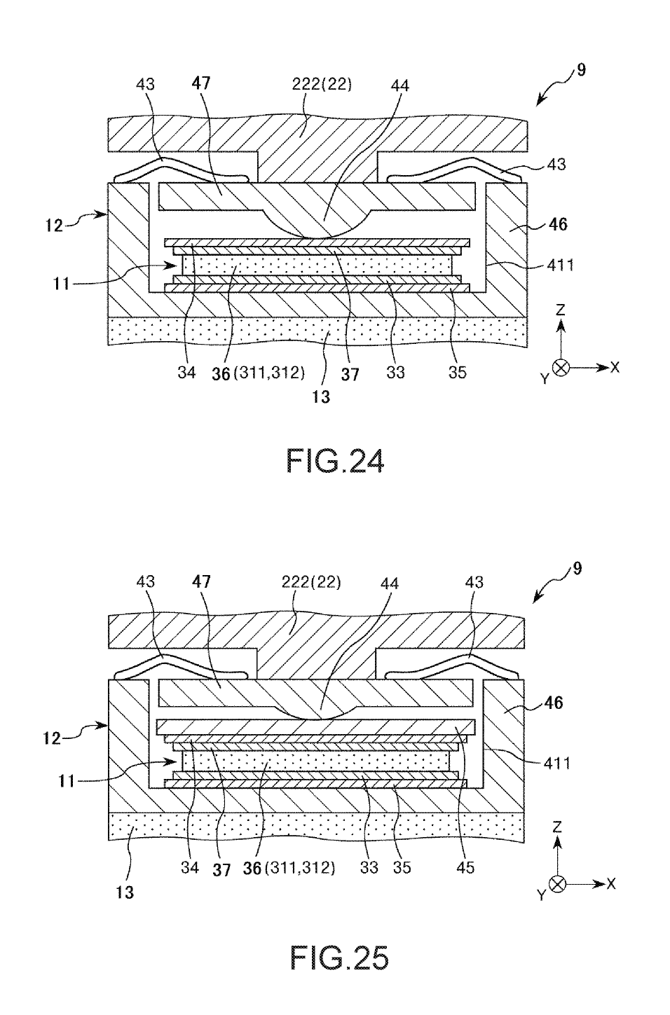

FIG. 24 is a cross-sectional view showing a pressing apparatus (electronic part holder) according to the present embodiment. FIG. 25 is a cross-sectional view showing a variation of the pressing apparatus (electronic part holder) shown in FIG. 24.

The electronic part holder 9 according to the present embodiment is the same as the electronic part holder 9 according to the fifth embodiment described above primarily except that the pressurizing section is configured differently.

In the following description, the description of the electronic part holder 9 according to the present embodiment will be primarily made about differences from the fifth embodiment described above, and the same items will not be described.

The pressurizing section 12 in the present embodiment includes a pressing section 44, which protrudes from the lid 47 toward the sensor section 11, as shown in FIG. 24. The pressing section 44 presses the sensor section 11. According to the configuration described above, the pressing section 44 locally presses the sensor section 11 (presses a region of the sensor section 11 narrower than the region thereof in the fifth embodiment described above), whereby the pressure exerted in advance and the force F3 can be efficiently transmitted to the sensor section 11.

The pressing section 44 has a dome-shaped front end portion formed of a curved surface, and the front end portion is in contact with the sensor section 11. In the configuration in which the portion that is in contact with the sensor section 11 is formed of a curved surface, damage of the sensor section 11 due to the contact with the pressing section 44 can be avoided. It is, however, noted that the pressing section 44 does not necessarily have a specific shape. The pressing section 44 may be formed of a plurality of pressing sections 44. For example, a plurality of pressing sections 44 may be arranged along at least one of the X-axis direction and the Y-axis direction.

In the present embodiment, the pressing section 44 is integrated with the lid 47, but they may be members separate from each other. Further, in the present embodiment, the pressing section 44 is in contact with the sensor section 11 (support substrate 34). Instead, for example, a protective plate 45 may be provided between the pressing section 44 and the sensor section 11, so that the pressing section 44 is not directly in contact with the sensor section 11, as shown in FIG. 25. Providing the protective plate 45 can protect the sensor section 11 from the pressing section 44, whereby damage or any other deterioration of the sensor section 11 can be effectively avoided. The protective plate 45 is preferably hard and has high rigidity. The constituent material of the protective plate 45 is not limited to a specific material and may, for example, be iron, nickel, cobalt, aluminum, magnesium, titanium, tungsten, or any of a variety of other metals, an alloy or inter-metal compound containing at least one of the metals described above, or even an oxide, nitride, or carbide of the metals described above.

The present embodiment described above can also provide the same advantageous effects as those provided by the fifth embodiment described above.

### Seventh Embodiment

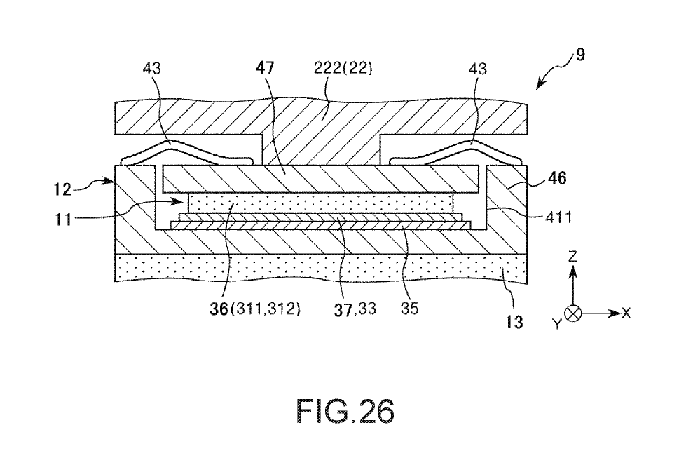

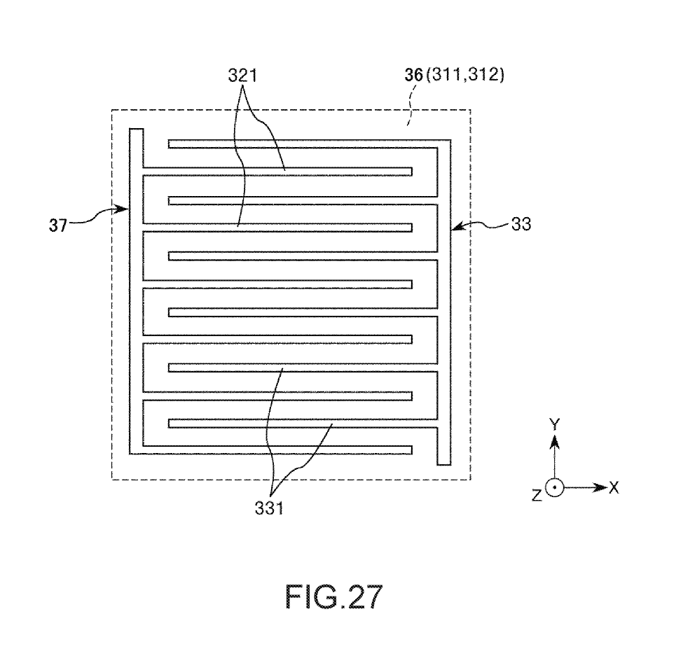

FIG. 26 is a cross-sectional view showing a pressing apparatus (electronic part holder) according to the present embodiment. FIG. 27 is a plan view showing the arrangement of a sensor section.

The electronic part holder 9 according to the present embodiment is the same as the electronic part holder 9 according to the fifth embodiment described above primarily except that the sensor section is configured differently.

In the following description, the description of the electronic part holder 9 according to the present embodiment will be primarily made about differences from the fifth embodiment described above, and the same items will not be described.

The sensor section 11 in the present embodiment includes the pressure sensitive section 36, the pair of electrodes 37 and 33, which are located on the lower surface of the pressure sensitive section 36, and the support substrate 35, which supports the electrodes 37 and 33, as shown in FIG. 26. That is, the electrodes 37 and 33 are located on the same side of the pressure sensitive section 36. The configuration described above allows the sensor section 11 to be thinner, for example, than in the fifth embodiment described above. In the present embodiment, the electrodes 37 and 33 are located on the lower surface of the pressure sensitive section 36 but may instead be located on the upper surface of the pressure sensitive section 36.

The electrodes 37 and 33 are each a comb-shaped electrode and are so disposed as to interleave with each other, as shown in FIG. 27. That is, the electrodes 37 and 33 are so disposed that electrode fingers 321 of the electrode 37 and electrode fingers 331 of the electrode 33 are alternately arranged. The electrodes 37 and 33 can therefore be so disposed as to spread over the entire region of the pressure sensitive section 36, whereby the sensor section 11 can reliably detect the force F3.

The present embodiment described above can also provide the same advantageous effects as those provided by the fifth embodiment described above.

### Eighth Embodiment

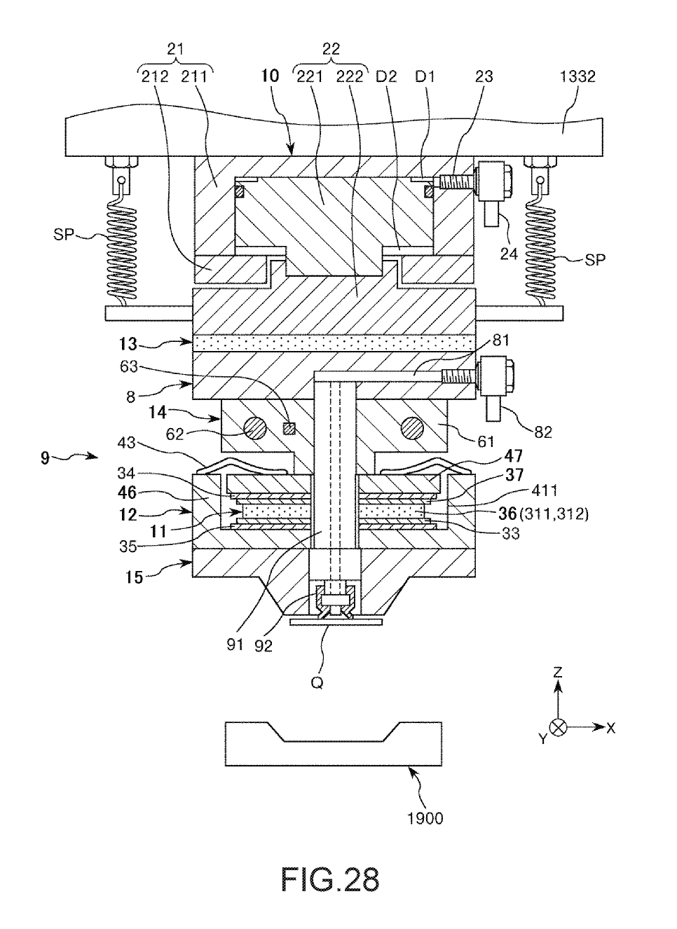

FIG. 28 is a cross-sectional view showing a pressing apparatus (electronic part holder) according to the present embodiment.

The electronic part holder according to the present embodiment is the same as the electronic part holder according to the fifth embodiment described above primarily except that the sensor section and the pressurizing section are arranged differently.

In the following description, the description of the electronic part holder according to the present embodiment will be primarily made about differences from the fifth embodiment described above, and the same items will not be described.

The heater 14 in the present embodiment is located on the side opposite the contact pusher 15 with respect to the sensor section 11, as shown in FIG. 28. In other words, the sensor section 11 is located between the heater 14 and the contact pusher 15. The configuration described above allows the distance between the sensor section 11 and the contact pusher 15 to be shortened as compared with, for example, the fifth embodiment described above, whereby the sensor section 11 can more precisely detect the force F3. In the arrangement described above, the heat produced by the heater 14 is undesirably transferred to the sensor section 11, but the sensor section 11 hardly experiences variation (drift) in the detection signal due to a change in temperature, as described above. The sensor section 11 in the present embodiment can therefore show an excellent detection characteristic, as in the fifth embodiment described above. That is, it can also be said that the fact that the sensor section 11 is unlikely to be affected by heat allows the arrangement in the present embodiment to be employed.

Further, in the present embodiment, the sucking tube 91 and the adhesion pad 92 are so provided as to pass through the sensor section 11 and the pressurizing section 12. It is, however, noted that the sucking tube 91 and the adhesion pad 92 can detour around the sensor section 11 and the pressurizing section 12, unlike in FIG. 28.

The present embodiment described above can also provide the same advantageous effects as those provided by the fifth embodiment described above.

### Ninth Embodiment

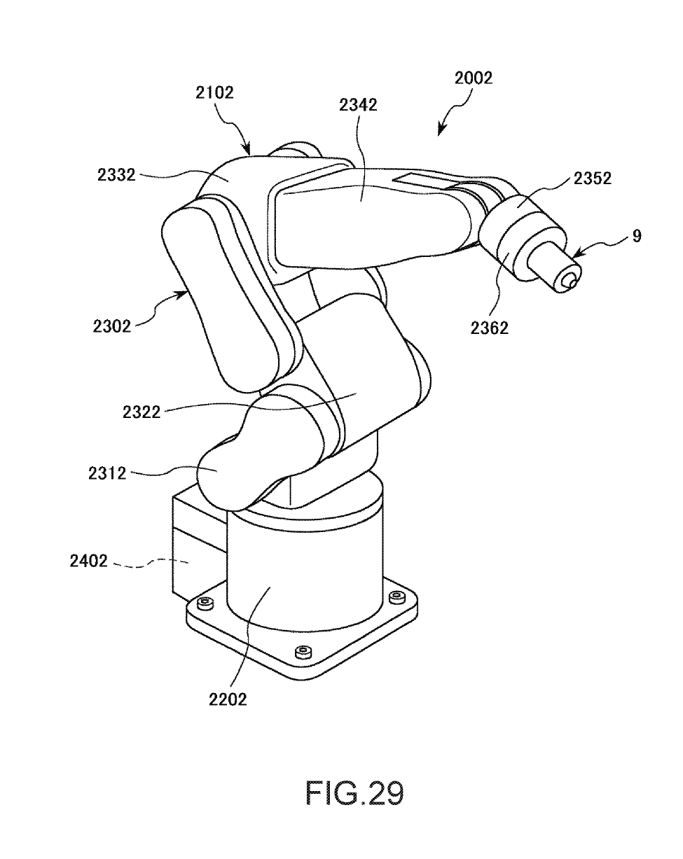

FIG. 29 is a perspective view showing a robot according to the present embodiment.

A robot 2002 shown in FIG. 29 can deliver, remove, transport, assemble, and otherwise work a precision apparatus and a part (target object) that form the precision apparatus. The thus functioning robot 2002 includes a robot main body 2102 and the electronic part holder 9 connectable to the robot main body 2102.

The robot main body 2102 includes a base 2202, which is fixed to a floor or a ceiling, an arm 2302, which is pivotably connected to the base 2202, and a robot controller 2402, under which the arm 2302 is driven. The arm 2302 includes a first arm 2312 pivotably linked to the base 2202, a second arm 2322 pivotably linked to the first arm 2312, a third arm 2332 pivotably linked to the second arm 2322, a fourth arm 2342 pivotably linked to the third arm 2332, a fifth arm 2352 pivotably linked to the fourth arm 2342, and a sixth arm 2362 pivotably linked to the fifth arm 2352. The electronic part holder 9 as the pressing apparatus is connected to the sixth arm 2362. The electronic part holder 9 can be any of the electronic part holders 9 in the fifth, sixth, seventh, and eighth embodiments described above or can be an electronic part holder differently configured in the present embodiment.

The thus configured robot 2002 includes the electronic part holder 9 as the pressing apparatus. The robot 2002 can therefore advantageously receive the effects provided by the electronic part holder 9 and show high reliability.

### Tenth Embodiment

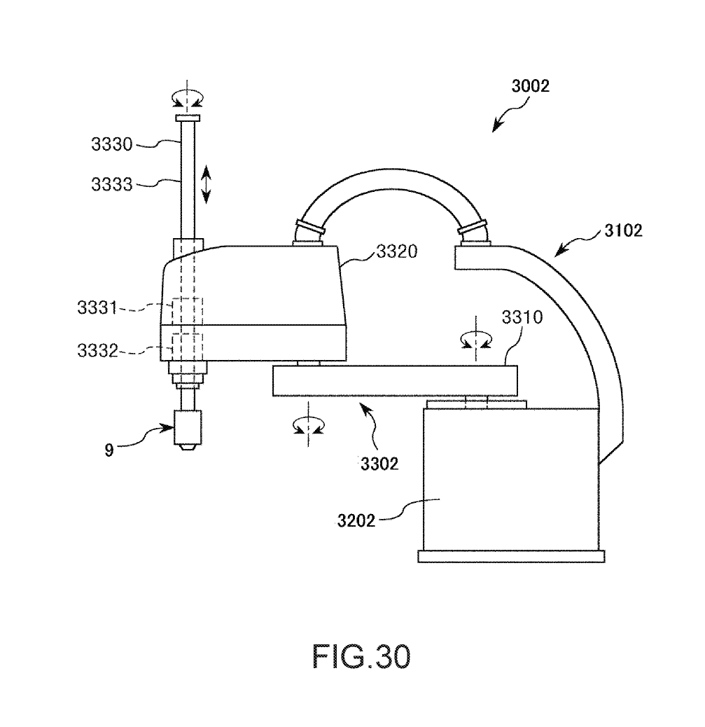

FIG. 30 is a side view showing a robot according to the present embodiment.

A robot 3002 shown in FIG. 30 is a horizontal multi-joint robot (SCARA robot). The robot 3002 includes a robot main body 3102 and the electronic part holder 9 connectable to the robot main body 3102. The electronic part holder 9 has been described above.

The robot main body 3102 includes a base 3202, which is fixed to a floor or a ceiling, and an arm 3302, which is pivotably connected to the base 3202. The arm 3302 includes a first arm 3310 pivotably linked to the base 3202, a second arm 3320 pivotably linked to the first arm 3310, and a work head 3330 provided in the second arm 3320.

The work head 3330 is disposed in a front end portion of the second arm 3320. The work head 3330 includes a spline nut 3331 and a ball screw nut 3332, which are coaxially arranged, and a spline shaft 3333, which is inserted into the spline nut 3331 and the ball screw nut 3332. The spline shaft 3333 can be rotated relative to the second arm 3320 around the axis thereof and lifted and lowered relative to the second arm 3320 in the upward/downward direction. The electronic part holder 9 as the pressing apparatus is attached to a front end portion (lower end portion) of the spline shaft 3333.

The thus configured robot 3002 includes the electronic part holder 9 as the pressing apparatus. The robot 3002 can therefore advantageously receive the effects provided by the electronic part holder 9 and show high reliability.

The pressing apparatus, the electronic part transport apparatus, the electronic part test apparatus, and the robot according to the embodiments of the invention have been described above with reference to the drawings, but the invention is not limited thereto, and the configuration of each portion in any of the embodiments can be replaced with an arbitrary configuration having the same function. Further, another arbitrarily constituent part may be added to any of the embodiments of the invention, and the embodiments may be combined with each other as appropriate.

The above embodiments have been described with reference to the configuration in which the electronic part holder as the pressing apparatus includes the movement mechanism (air cylinder), the sensor section, the pressurizing section, the heat insulating section, the heating section (heater), and the pressing section (contact pusher), but the configuration of the electronic part holder only needs to include the sensor section (pressure sensitive section) and the pressing section, and the other sections are arbitrarily provided and do not necessarily have specific configurations. Therefore, for example, at least one of the movement mechanism (air cylinder), the pressurizing section, the heat insulating section, and the heating section (heater) may be omitted, and any other element may be provided.

The above embodiments have been described with reference to the case where the electronic part transport apparatus is used in an electronic part test apparatus, but the electronic part transport apparatus may not be used in an electronic part test apparatus and may be used in an apparatus having another function. In this case, the target object is not limited to an electronic part (that is, part required to be tested).

The entire disclosures of Japanese Patent Application No. 2016-212639, filed Oct. 31, 2016 and No. 2016-212646, filed Oct. 31, 2016 are expressly incorporated by reference herein.

What is claimed is:

1. A hand comprising:
a grasper that grasps a target object; and
a sensor section that detects force exerted on the grasper when the grasper grasps the target object,
wherein the sensor section includes a pressure sensitive section including a resin and carbon nanotubes.

2. The hand according to claim 1, wherein the sensor section is disposed between the target object and the grasper in a state in which the grasper grasps the target object.

3. The hand according to claim 2, wherein the sensor section is capable of independently detecting the force in a plurality of portions of the sensor section.

4. The hand according to claim 1, further comprising:
a base section; and
a movable section movable relative to the base section,
wherein the grasper is connected to the movable section, and
the sensor section is also disposed between the movable section and the grasper.

5. The hand according to claim 4, wherein the sensor section disposed between the movable section and the grasper is formed of a plurality of sensor sections arranged along a direction perpendicular to a movement direction of the movable section.

6. The hand according to claim 1, wherein the resin contains a thermoplastic resin.

7. The hand according to claim 6, wherein the resin contains polycarbonate.

8. The hand according to claim 1, wherein the resin contains a thermoset resin.

9. The hand according to claim 1,
wherein the sensor section includes a pair of electrodes, and
the pressure sensitive section disposed between the pair of electrodes.

10. The hand according to claim 1,
wherein the sensor section includes a pair of electrodes, and
the pair of electrodes are located on the pressure sensitive section and on the same side thereof.

11. A robot comprising the hand according to claim 1.

12. A robot comprising the hand according to claim 2.

13. A robot comprising the hand according to claim 3.

14. A robot comprising the hand according to claim 4.

15. A robot comprising the hand according to claim 5.

16. A robot comprising the hand according to claim 6.

17. A robot comprising the hand according to claim 7.

18. A robot comprising the hand according to claim 8.

19. A robot comprising the hand according to claim 9.

20. A robot comprising the hand according to claim 10.
